(19) United States
(12) Patent Application Publication
(10) Pub. No.: US 2014/0046748 A1
(43) Pub. Date: Feb. 13, 2014

(54) OFFERS BASED ON PRE-PURCHASE INTENT

(71) Applicants: Srinath Nagarajan, Charlotte, NC (US); Matthew Laine Donlan, Charlotte, NC (US)

(72) Inventors: Srinath Nagarajan, Charlotte, NC (US); Matthew Laine Donlan, Charlotte, NC (US)

(73) Assignee: Bank of America Corporation, Charlotte, NC (US)

(21) Appl. No.: 13/572,800

(22) Filed: Aug. 13, 2012

(51) Int. Cl. G06Q 30/02

(52) U.S. Cl. 705/14.35; 705/14.1

(57) ABSTRACT

Embodiments of the invention are directed to systems, methods and computer program products for transmitting offers based on pre-purchase intent. An exemplary apparatus is configured to: receive a declaration of intent from a user, the declaration of intent being associated with an intended purchase; transmit the declaration of intent to at least one merchant; receive an offer from the at least one merchant, the offer being based on the declaration of intent, and the offer enabling the user to receive a discount or rebate on the intended purchase; and transmit the offer to the user.

### BACKGROUND

When an entity sends a targeted purchase offer to a potential customer, there is a greater likelihood that the potential customer actually takes advantage of the purchase offer. By sending purchase offers to potential customers who will likely use the purchase offers and excluding those who will likely not use the purchase offers, an entity can save millions of dollars in sending out purchase offers to those who will likely not use the purchase offers. Therefore, there is a need for a system to produce targeted purchase offers.

### BRIEF SUMMARY

Embodiments of the invention are directed to systems, methods, and computer program products for transmitting offers based on pre-purchase intent. In some embodiments, an apparatus is provided for transmitting offers based on pre-purchase intent. The apparatus comprises a memory; a processor; and a module stored in the memory, executable by the processor, and configured to: receive a declaration of intent from a user, the declaration of intent being associated with an intended purchase; transmit the declaration of intent to at least one merchant; receive an offer from the at least one merchant, the offer being based on the declaration of intent, and the offer enabling the user to receive a discount or rebate on the intended purchase; and transmit the offer to the user.

In some embodiments, the declaration of intent is associated with at least one of a type of purchase or a type of merchant.

In some embodiments, the declaration of intent is associated with at least one of a user-selected time period or a user-defined budget.

In some embodiments, the declaration of intent is associated with a geographical area.

In some embodiments, the transmitting the declaration of intent to at least one merchant comprises transmitting the declaration of intent along with at least one of user information or account information associated with the user.

In some embodiments, the declaration of intent is associated with a plurality of users.

In some embodiments, the module is configured to identify each of the plurality of users.

In some embodiments, the discount or rebate is applied to a transaction associated with each of the plurality of users.

In some embodiments, a first user, among the plurality of users, activates the offer, and a second user, among the plurality of users, executes a transaction associated with the intended purchase.

In some embodiments, the declaration of intent is received via at least one of a financial institution account, a social networking account, email, voice mail, or text message.

In some embodiments, the at least one merchant is given a predetermined period to transmit the offer associated with the declaration of intent.

In some embodiments, the offer is transmitted to the user in real-time or near real-time.

In some embodiments, the offer is transmitted to the user based on offer information associated with the offer substantially matching at least one of user information or account information associated with the user, wherein the account information comprises a transaction history associated with the user's financial institution account, and wherein the transaction history comprises at least one of a type of a transaction, a frequency associated with the transaction, an amount associated with the transaction, or a merchant associated with the transaction, and wherein the user information comprises personal information associated with at least one of the user, a family member of the user, or a friend of the user, wherein the personal information comprises at least one of demographic information, salary information, contact information, residence address information, job profile information, education information, or social network information.

In some embodiments, the offer is transmitted to the user based on the user not being excluded by at least one user exclusion rule and the merchant not being excluded by at least one merchant exclusion rule, wherein the at least one user exclusion rule comprises at least one of an affinity exclusion rule, a risk exclusion rule, or an account exclusion rule, and wherein the at least one merchant exclusion rule comprises a merchant category code exclusion rule, and wherein the at least one merchant exclusion rule is based at least partially on a list of merchants associated with an excluded merchant category code that are not excluded.

In some embodiments, the offer is presented to the user on a portable mobile communication device.

In some embodiments, a transaction associated with the intended purchase comprises: at least one purchase associated with a predetermined period, at least one purchase associated with a predetermined amount, an aggregate of a plurality of purchases, or a largest purchase.

In some embodiments, the offer is transmitted via at least one of a user interface associated with the user's financial institution account, a user interface associated with the user's social network account, email, or text message.

In some embodiments, the processing of a transaction associated with the intended purchase is executed as part of a batch processing operation, wherein the batch processing operation comprises processing a plurality of financial institution accounts.

In some embodiments, a method is provided for transmitting offers based on pre-purchase intent. The method comprises: receiving a declaration of intent from a user, the declaration of intent being associated with an intended purchase; transmitting the declaration of intent to at least one merchant; receiving an offer from the at least one merchant, the offer being based on the declaration of intent, and the offer enabling the user to receive a discount or rebate on the intended purchase; and transmitting the offer to the user.

In some embodiments, a computer program product is provided for transmitting offers based on pre-purchase intent. The computer program product comprises a non-transitory computer-readable medium comprising a set of codes for causing a computer to: receive a declaration of intent from a user, the declaration of intent being associated with an intended purchase; transmit the declaration of intent to at least one merchant; receive an offer from the at least one merchant, the offer being based on the declaration of intent, and the offer enabling the user to receive a discount or rebate on the intended purchase; and transmit the offer to the user.

### BRIEF DESCRIPTION OF THE DRAWINGS

Having thus described embodiments of the invention in general terms, reference will now be made to the accompanying drawings, where:

FIG. 1 is a flowchart illustrating a general process flow for implementing rule-based offer association, in accordance with embodiments of the present invention;

FIG. 2 is a flowchart illustrating a general process flow for queuing input information for performing rule-based offer association, in accordance with embodiments of the present invention;

FIG. 3 is a flowchart illustrating a general process flow for implementing an intelligent offer tool, in accordance with embodiments of the present invention;

FIG. 4 is a block diagram illustrating technical components of a system for implementing the various processes described herein, in accordance with embodiments of the present invention;

FIG. 5 is a flowchart illustrating a general process flow for substituting a first offer with a second offer, in accordance with embodiments of the present invention;

FIG. 6 is a flowchart illustrating a general process flow for applying offers to purchase transactions at settlement, in accordance with embodiments of the present invention;

FIG. 7 is another flowchart illustrating a general process flow for applying offers to purchase transactions at settlement (offers based on user activity), in accordance with embodiments of the present invention;

FIG. 8 is another flowchart illustrating a general process flow for applying offers to purchase transactions at settlement (incentive for offer distribution), in accordance with embodiments of the present invention;

FIG. 9 is a flowchart illustrating a general process flow offer aggregation, in accordance with embodiments of the present invention;

FIG. 10 is a flowchart illustrating a general process flow for sequential offer aggregation, in accordance with embodiments of the present invention; and

FIG. 11 is a flowchart illustrating a general process flow for transmitting offers based on pre-purchase intent, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for implementing rule-based offer association and queuing input information for performing rule-based offer association, and an offer tool for determining whether to present an offer to a user. Additionally, embodiments of the invention are directed to systems, methods, and computer program products for transmitting offers based on pre-purchase intent. The invention enables an entity to send targeted offers to a user that enables the user to receive at least one of a discount or a rebate on a purchase from a third-party merchant. As used herein, an offer may also be referred to as a coupon (e.g., an electronic coupon).

In some embodiments, an “entity” may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, or the like. The account is associated with and/or maintained by the entity. In other embodiments, an entity may not be a financial institution. In still other embodiments, the entity may be the merchant itself.

In some embodiments, the “user” may be a customer (e.g., an account holder or a person who has an account (e.g., banking account, credit account, or the like) at the entity) or potential customer (e.g., a person who has submitted an application for an account, a person who is the target of marketing materials that are distributed by the entity, a person who applies for a loan that not yet been funded).

As an example, an entity (e.g., a financial institution) may send an offer to a user (e.g., an account holder). The offer may be presented to the user via at least one of the user's electronic banking account (e.g., online banking account, mobile banking account on a portable mobile communication device, or the like), the user's social network account, email, or text message. In some embodiments, the user may select an option associated with the presented offer to accept the offer. When the user accepts the offer, the offer is activated so that if the user uses an eligible payment method (as determined by the entity or the merchant) to make a purchase associated with the offer, the user receives the benefit associated with the offer. In other embodiments, the offer may be automatically activated if the user has previously chosen to automatically activate offers associated with particular types (e.g., associated with particular merchants or product or service types). In some embodiments, the entity or the merchant may determine that a user may choose among multiple eligible payment methods in order to make a purchase associated with the offer.

As an example, the activated offer may be a rebate of $5 on a purchase of $20 from a department store. The user may decide to use the offer by visiting the department store and making a purchase of $20. In some embodiments, at the point of sale, the user pays $20 for the user's purchase using an eligible payment method determined by the financial institution or the merchant (e.g., payment card, mobile device payment, check, or the like). When the transaction is processed by the financial institution at a predetermined settlement time in the future (e.g., as part of a periodic batch processing operation to generate monthly account statements), the financial institution provides a rebate of $5 to the user's financial institution account. Therefore, the department store, at the point of sale, may have no knowledge that the user will receive a rebate at some point in the future. In some embodiments, even the user may not be aware of the rebate at the point of sale (e.g., if the offer was automatically activated). In other embodiments, the point of sale terminal may provide an indication to at least one of the department store or the user that the user will receive a rebate at some point in the future.

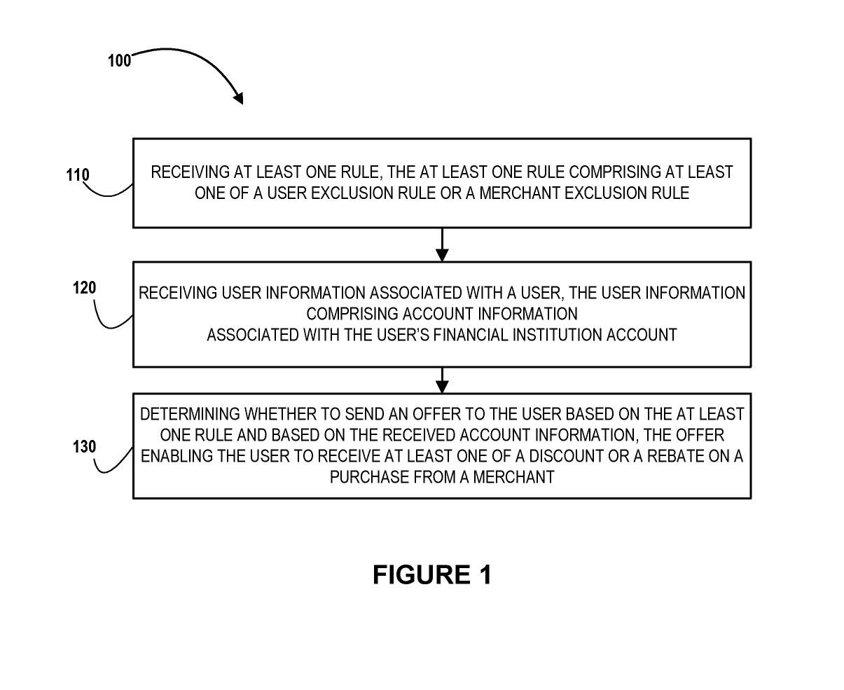

Referring now to FIG. 1, a general process flow 100 is provided for implementing rule-based offer association. At block 110, the method comprises receiving at least one rule, the at least one rule comprising at least one of a user exclusion (or user filtering) rule or a merchant exclusion (or merchant filtering) rule. At block 120, the method comprises receiving user information associated with a user, the user information comprising account information associated with the user's financial institution account. At block 130, the method comprises determining whether to send an offer to the user based on the at least one rule and based on the received user information, the offer enabling the user to receive at least one of a discount or a rebate on a purchase from a merchant. As described previously, in some embodiments, the discount or rebate is received at a point of time in the future when the transaction that qualifies for the offer is processed by the financial institution.

In some embodiments, account information, as used herein, refers to information associated with the user's financial institution account(s) managed by a single financial institution. In other embodiments, account information may refer to information associated with the user's financial institution accounts managed by multiple distinct financial institutions.

As used herein, a user exclusion rule is a rule that excludes some users from receiving offers. In some embodiments, the at least one user exclusion rule comprises an affinity exclusion rule. Therefore, if the financial institution (or a merchant partner associated with the financial institution) already has an existing relationship (e.g., for providing or sending offers associated with the particular merchant) with some users via an affinity program, those users are excluded from receiving an offer. The affinity exclusion rule comprises at least one of a full affinity exclusion rule or a partial affinity exclusion rule. When the affinity rule comprises a full affinity exclusion rule, the user is completely excluded from receiving an offer (e.g., an offer associated with a particular merchant) if the financial institution (or a merchant partner associated with the financial institution) already has an existing relationship with the user. When the affinity rule comprises a partial affinity exclusion rule, the user is excluded from receiving an offer associated with a particular product, service, or industry associated with a particular merchant that already has an existing relationship with the user for the particular product, service, or industry, but the user may receive offers associated with other products, services, or industries associated with the particular merchant. Additionally or alternatively, the user is excluded from receiving an offer associated with a competitor of a particular merchant if that particular merchant already has an existing relationship with the user.

In some embodiments, the at least one user exclusion rule comprises a risk exclusion rule. Therefore, if a user is determined to be a risky user (e.g., has a credit score lower than a predetermined threshold), the user is excluded from receiving an offer. In some embodiments, the at least one user exclusion rule comprises an account exclusion rule. Therefore, for example, if a user's account has a balance (or another account characteristic) that is lower than predetermined threshold, the user is excluded from receiving an offer.

In some embodiments, a merchant exclusion rule is a rule that excludes some merchants from providing offers to users associated with the financial institution. In some embodiment, the at least one merchant exclusion rule comprises a merchant category code exclusion rule. Therefore, a merchant associated with a predetermined merchant category code (e.g., a healthcare code) is excluded from providing an offer. However, the financial institution may set up a list of merchants that trigger exceptions. Merchants that trigger exceptions can provide offers even if these merchants are associated with the excluded merchant category codes.

In some embodiments, the account information comprises a transaction history associated with the user's financial institution account. The transaction history includes the types of transactions, frequency of transactions, amount of each transaction, merchants associated with transactions, account balance history, or the like. Additionally or alternatively, the account information may or may not comprise information associated with incorrect, inconsistent, incomplete, or corrupted transactions. As used herein, a transaction may comprise a purchase, a deposit, a withdrawal, a credit, a debit, or the like.

In some embodiments, the user information comprises other information as well. For example, in some embodiments, the user information comprises personal information (e.g., demographic information, salary information, contact information (mailing address, email address, phone number, or the like), residence address history, education information, job profile information, or the like) associated with the user. In some embodiments, the personal information further comprises social network information associated with the user's social network account or other non-account related information associated with the user. In some embodiments, the user information further comprises user information (e.g., personal information, account information, or the like) associated with the user's immediate or extended family members or contacts (e.g., as determined from social network information).

In some embodiments, when a purchase transaction is processed by the financial institution at a predetermined time in the future (i.e., at settlement time or processing time), the system determines whether the offer is still active and whether the offer is still valid with respect to both the user and the merchant. This post-transaction process may be referred to as an offer reconciliation process. The offer is still active if the offer has not been revoked by at least one of the financial institution or the merchant and/or if the offer has not expired.

The offer is valid with respect to the merchant if the merchant is not excluded under any merchant exclusion rules. As described previously, the merchant's offer may be transmitted to or presented to the user if the merchant is not excluded under any merchant exclusion rules. In some embodiments, in order for the offer to be valid, the merchant cannot be excluded under any merchant exclusion rules that were in force at the time of the purchase transaction. Additionally or alternatively, in some embodiments, in order for the offer to remain valid, the merchant cannot be excluded under any merchant exclusion rules that are in force at the time of settlement of the offer. Therefore, in some embodiments, the merchant cannot be excluded under any new merchant exclusion rules that have been introduced since the purchase transaction.

The offer is valid for the user if the user is not excluded under any user exclusion rules. As described previously, the user is presented with the merchant's offer if the user is not excluded under any user exclusion rules. In some embodiments, in order for the offer to be valid, the user cannot be excluded under any user exclusion rules that were in force at the time of the purchase transaction. Additionally or alternatively, in some embodiments, in order for the offer to remain valid, the user cannot be excluded under any user exclusion rules that are in force at the time of settlement of the offer. Therefore, in some embodiments, the user cannot be excluded under any new user exclusion rules that have been introduced since the purchase transaction.

If both the user and the merchant are not excluded at the time of settlement, the offer is still valid and the financial institution provides a rebate to the user's financial institution account. In some embodiments, if at least one of the user or the merchant is excluded at the time of settlement, the offer is invalid and the financial institution does not provide a discount or rebate to the user's financial institution account. However, in alternate embodiments, even if at least one of the user or the merchant is excluded at the time of settlement, the offer remains valid as long as the user and the merchant were not excluded at the time of the purchase transaction, and consequently the financial institution provides a discount or rebate to the user's financial institution account.

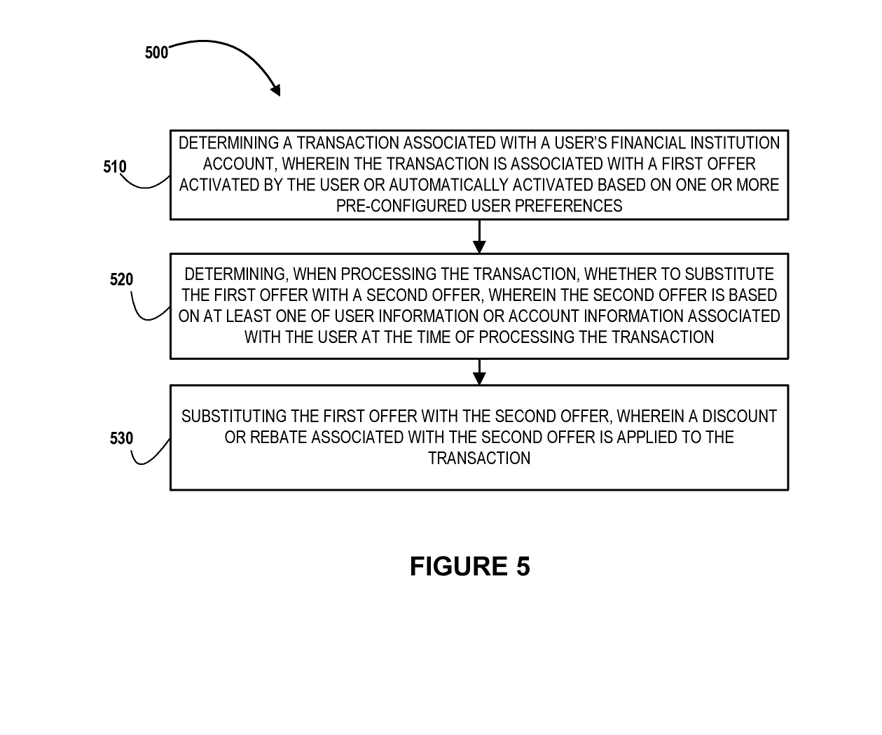

Referring now to FIG. 5, a general process flow 500 is provided for substituting a first offer with a second offer. At block 510, the method comprises determining a transaction associated with a user's financial institution account, wherein the transaction is associated with a first offer activated by the user of the financial institution account or automatically activated based on one or more pre-configured user preferences. At block 520, the method comprises determining, when processing the transaction, whether to substitute the first offer with a second offer, wherein the second offer is based on at least one of user information or account information associated with the user at the time of processing the transaction. At block 530, the method comprises substituting the first offer with the second offer, wherein a discount or rebate associated with the second offer, and not the first offer, is applied to the transaction. The process for substituting a first offer with a second offer is described herein. In some embodiments, the first offer is substituted with the second offer at the time of processing the transaction based on information associated with the user's relationship (e.g., account information or user information described herein) with the financial institution.

When the first offer is substituted with the second offer, a notification may be transmitted to the user. The notification may be transmitted via email, text message, social networking message, or the like. The notification may indicate the reasons for the substituting the first offer with the second offer, and the effect of substituting the first offer with the second offer (e.g., the user receives a bigger discount or rebate). The notification may be transmitted either prior to, at, or after the offer substitution. In some embodiments, the user may select an option on the user's mobile device to either accept or reject the offer substitution.

In some embodiments, at the time of settlement of the offer (referred to as the first offer), the system determines whether to substitute the first offer with a second offer. If the first offer is substituted with the second offer, a rebate or discount associated with the second offer, and not the first offer, is applied to the transaction or to the user's financial institution account.

The time of settlement of the offer may also be referred to as the time of processing the transaction.

In some embodiments, the first offer is substituted with the second offer if the first offer, which was active when the transaction occurred, has been revoked by at least one of the financial institution or a merchant prior to the processing of the transaction. In some embodiments, the first offer is substituted with the second offer if the first offer, which was active when the transaction occurred, has expired by the time of processing of the transaction.

In some embodiments, the first offer is transmitted to or presented to the user based on at least one of user information or account information described herein. As explained herein, the account information comprises a transaction history associated with the user's financial institution account. The transaction history may comprise at least one of a type of a transaction, a frequency associated with the transaction, an amount associated with the transaction, or a merchant associated with the transaction. Additionally or alternatively, the account information comprises an account balance history. As explained herein, the user information comprises personal information associated with at least one of the user, a family member of the user, or a friend of the user, wherein the personal information comprises at least one of demographic information, salary information, contact information, residence address information (may also be referred to as mailing address information), job profile information, education information, or social network information.

Therefore, the first offer is transmitted to or presented to the user based on substantially matching the user information or account information to the first offer information. For example, the first offer is based on the residence address of the user or based on the transaction history of the user's financial institution account. The first offer may be substituted with the second offer based on a change in the user information or account information described herein. For example, the user may change the user's residence address between the occurrence of the purchase transaction and the processing of the transaction. As a further example, the user's purchase habits may change (consequently resulting in a change in the transaction history) between the occurrence of the purchase transaction and the processing of the transaction. When there is a change in the user information or account information, the first offer information no longer substantially matches at least one of the user information or account information. The first offer is therefore replaced with a second offer at the time of processing the transaction, where the second offer information substantially matches at least one of the user information or account information at the time of processing the transaction.

As explained herein, the first offer is transmitted to or presented to the user based at least partially on the user not being excluded by at least one user exclusion rule associated with the first offer and the merchant not being excluded by at least one merchant exclusion rule associated with the first offer. As explained herein, a user exclusion rule comprises at least one of an affinity exclusion rule, a risk exclusion rule, or an account exclusion rule, and a merchant exclusion rule comprises a merchant category code exclusion rule. Additionally, as explained herein, some merchants associated with an excluded merchant category code are not excluded. As explained earlier, the first offer that was valid at the time of the transaction may not be valid at the time of processing the transaction because the user or the merchant may be excluded from the first offer by at least one of a user exclusion rule or a merchant exclusion rule. The user may be excluded based on a change in account information (e.g., change in transaction history) or change in user information (e.g., change in residence address) associated with the user. The merchant may be excluded based on a change in information (e.g., change in merchant category code) associated with the merchant.

In some instances, a user exclusion rule or a merchant exclusion rule associated with the first offer may change between the occurrence of the purchase transaction and the processing of the transaction, and that change may cause the user to be excluded or the merchant to be excluded thereby resulting in the user not receiving a rebate or discount associated with the first offer. In other instances, a user exclusion rule or a merchant exclusion rule associated with the first offer may be introduced after the occurrence of the transaction, and this new user exclusion rule or merchant exclusion rule may cause the user or merchant to be excluded thereby resulting in the user not receiving a rebate or discount associated with the first offer. Therefore, in such instances where the user or the merchant is excluded, at the time of processing the transaction, by a user exclusion rule or a merchant exclusion rule associated with the first offer, the first offer may be substituted with a second offer, where neither the user nor the merchant is excluded by a user exclusion rule or a merchant exclusion rule associated with the second offer at the time of processing the transaction.

As described previously, the first offer is an offer that is transmitted to or presented to the user. The first offer is either manually activated by the user or is automatically activated based on one or more preferences established by the user. In some embodiments, the second offer is an offer that has neither been transmitted to or presented to the user, nor has been activated by the user, and nor has been activated based on one or more pre-configured user preferences. The second offer may be an offer that was introduced by the merchant after the purchase transaction has already occurred. In alternate embodiments, the second offer may be an offer that was presented to the user but was neither activated by the user nor activated based on one or more preconfigured user preferences. In other alternate embodiments, the second offer may be an offer that was presented to the user and activated by the user or activated based on one or more pre-configured user preferences.

In some embodiments, the first offer is substituted with the second offer if the second offer provides a bigger discount or rebate and the user qualifies for the second offer at the time of processing the transaction based on the user information and/or the account information associated with the user. In some embodiments, the second offer may be a discount or rebate that is applied to a different transaction from the transaction associated with the first offer, and consequently no offers may be applied to the transaction associated with the first offer. In some embodiments, the different transaction may be associated with a different merchant. Therefore, the second offer may be associated with a different merchant from the first offer. The system may apply the second offer to a different transaction because the resulting rebate is larger compared to the second offer being applied to the original transaction.

In some embodiments, the first offer may be substituted with a second offer, where the second offer provides a smaller rebate or discount compared to the first offer. The substitution may have been necessitated because a condition associated with substituting the first offer with a second offer has been satisfied (e.g., change in at least one of user information or account information between occurrence of the transaction and processing of the transaction, change in user exclusion rule or merchant exclusion rule between occurrence of the transaction and processing of the transaction, first offer has been revoked or has expired at the time of processing the transaction, or the like).

As explained herein, a user may also refer to a family or a household comprising a plurality of users (e.g., husband, wife, and kids). The account information and/or user information associated with the various users in the household may be considered cumulatively for various purposes described herein (e.g., offer substitution). The account information may comprise account information associated with a single account that is accessible to the various users in the household, or may comprise account information associated with separate accounts associated with various users in the household.

In some embodiments, the system described herein may determine that the user has activated an offer, but has not made a purchase associated with the offer for a predetermined period after activating the offer. Additionally, the system may determine, based on the user's account information (e.g., transaction history), that the user has made purchases for goods or services at a merchant that competes with the merchant associated with the activated offer. In order to encourage the user to make a purchase associated with the activated offer, the system may adjust the offer (e.g., increase the rebate or discount amount associated with the offer, replace the merchant associated with the offer with the merchant from which the user made purchases during the predetermined period, or the like). The offer adjustment may be communicated to the user to encourage the user to make a purchase associated with the adjusted offer. Additionally or alternatively, the system may, at the time of settlement of the user's purchase made during the predetermined period after activating the offer, substitute the offer with the adjusted offer (may be referred to as the second offer) so that the user receives a discount or rebate on the user's purchase. Prior to applying the adjusted offer, the system determines whether the user qualifies for the adjusted offer.

In some embodiments, the system described herein may determine that the user does not activate offers associated with a particular merchant (and/or service or good), but has made purchases from a competing merchant for similar services or goods. Based on this determination, the system may, in the future, transmit to the user offers associated with the merchant from which the user made purchases. In other embodiments, at the time of settlement of the user's purchases, the system applies an offer associated with the merchant from which the user made purchases. Prior to applying the offer, the system determines whether the user qualifies for the offer.

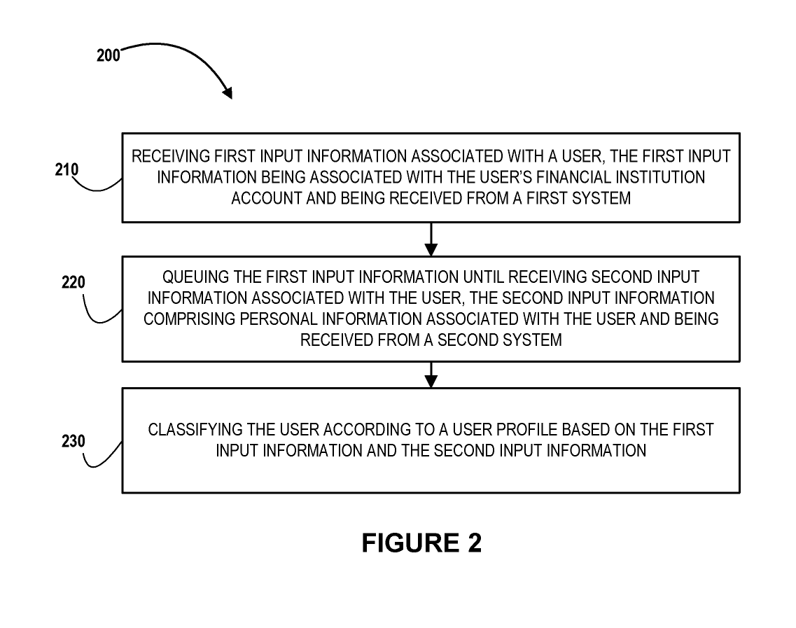

Referring now to FIG. 2, a general process flow 200 is provided for queuing input information for performing rule-based offer association. The input information may include various types of information associated with a user. For example, the input information may include account information associated with the user's financial institution account and personal information associated with the user or the user's financial institution account. In some embodiments, the input information may include information received from external systems (e.g., systems not managed by the financial institution that manages the user's financial institution account). For example, the input information may include social network information associated with the user's social network account. Therefore, each type of input information is queued on a single queue (or multiple queues) until enough input information is received to classify the user based on one or more predetermined user profiles as described below. The invention is not limited to any duration of time that the input information spends on a queue.

At block 210, the method comprises receiving first input information associated with a user, the first input information being associated with the user's financial institution account and being received from a first system. At block 220, the method comprises queuing the first input information until receiving second input information associated with the user, the second input information comprising personal information associated with the user and being received from a second system. At block 230, the method comprises classifying the user according to a user profile based on the first input information and the second input information.

The first system is separate from the second system. In some embodiments, the first system and the second system may be managed by different entities. For example, the first system is managed by a financial institution that manages the user's financial institution account, and the second system is managed by an external entity that provides personal information regarding the user to the financial institution.

In alternate embodiments, the second input information, in addition to or instead of comprising personal information associated with the user and being received from a second system, comprises information associated with the user's financial institution account and is received from a third system that is managed by the financial institution. The third system is distinct from both the first and second systems, and the account information received from the third system is different from the account information received from the first system. For example, the account information received from the first system comprises the transaction history for a predetermined period of time (e.g., the previous three months), and the account information received from the third system comprises information regarding bill payment history associated with bills being paid from funds associated with the user's financial institution account. Alternatively, the account information received from the third system comprises information regarding mortgage payments associated with a mortgage loan provided by one of the financial institution that manages the user's financial institution account or a different financial institution. Alternatively, the account information received from the third system comprises the user's status. In some embodiments, the status may indicate whether the user is eligible to receive offers associated with particular purchases (either a past purchase or a future purchase) or particular merchants. In some embodiments, the status may indicate the standing of the user's financial institution account.

In other alternate embodiments, the first input information comprises personal information associated with the user that is received from the second system. This first input information is queued until second input information associated with the user's financial institution account is received from the first system.

In some embodiments, the first input information comprises information associated with single-holder accounts (no joint holders) associated with the user, and the second input information comprises information associated with joint accounts associated with the user.

In some embodiments, the process flow 200 further comprises receiving at least one rule; the at least one rule comprising at least one of a user exclusion rule or a merchant exclusion rule. In some embodiments, the process flow 200 further comprises determining whether to send an offer to the user based on the at least one rule and based on the received first input information and second input information, the offer enabling the user to receive at least one of a discount or a rebate on a purchase from a merchant.

In some embodiments, the first input information comprises a transaction history associated with the user's financial institution account. In some embodiments as described herein, the transaction history may be associated with a predetermined time period (e.g., the previous three months). The transaction history includes the types of transactions, frequency of transactions, amount of each transaction, merchants associated with transactions, account balance history, or the like. Additionally or alternatively, the account information may or may not comprise information associated with incorrect, inconsistent, incomplete, or corrupted transactions. As used herein, a transaction may comprise a purchase, a deposit, a withdrawal, a credit, a debit, or the like.

In some embodiments, the second input information (e.g., personal information) comprises demographic information, salary information, contact information (mailing address, email address, phone number, or the like), residence address history, social network information, education information, job profile information, or the like. In some embodiments, the second input information may also comprise personal information or account information associated with the user's immediate or extended family members or contacts (e.g., as determined from social network information).

In some embodiments, the user profile comprises a collection of users that are associated with similar characteristics. These characteristics may relate to the users' account transactional behavior (e.g., types of transactions, frequency of transactions, amount of each transaction, merchants associated with transactions, account balance history, or the like). As used herein, a transaction may comprise a purchase, a deposit, a withdrawal, a credit, a debit, or the like. Additionally or alternatively, these characteristics may relate to the users' personal characteristics (e.g., demographic information, salary information, location information, social network information, education information, job profile information, or the like).

In some embodiments, the first input information comprises account information or personal information associated with the user, and the second input information comprises account information or personal information associated with the user. Additionally, the financial institution may establish one or more criteria (e.g., the exclusion rules described herein) to determine whether the user qualifies to receive an offer associated with a merchant. Therefore, as an example, a user qualifies for an offer (or an offer is sent to a user) if two pieces of information (e.g., the user's transaction history and the user's mailing address) are received. The transaction history is received as part of the first input information and waits on a first queue. At a later point in time, the mailing address is received as part of the second input information. When the mailing address is received, the system determines that the criteria has been satisfied, and the first input information is combined with the second input information to determine that the user qualifies for the offer (or to determine that the offer can be transmitted to the user).

In some embodiments, the queue comprising the first input information is reorganized into a cached area of the system. Additionally or alternatively, the queue comprising the second input information is reorganized into a cached area of the system. This reorganization process improves the processing speed of any process that uses at least one of the first input information or the second input information.

In some embodiments, the system associated with the financial institution receives account information or personal information from a source either external to or internal to the financial instruction. For example, the system receives transaction history associated with a user from a merchant. The system described herein is enabled to receive information (e.g., a string of information) from an external source and identify and exclude some personal information (e.g., social security number, credit card number, or the like) associated with the user, where the excluded personal information is not considered in processing the input information associated with the user (e.g., determining whether the user qualifies to receive an offer). Therefore, for example, the system is enabled to determine a nine digit number (could be a social security number) in the string of information received from the merchant and exclude the nine digit number. As a further example, the system is enabled to determine a sixteen digit number (could be a credit or debit card number) in the string of information received from the merchant and exclude the sixteen digit number.

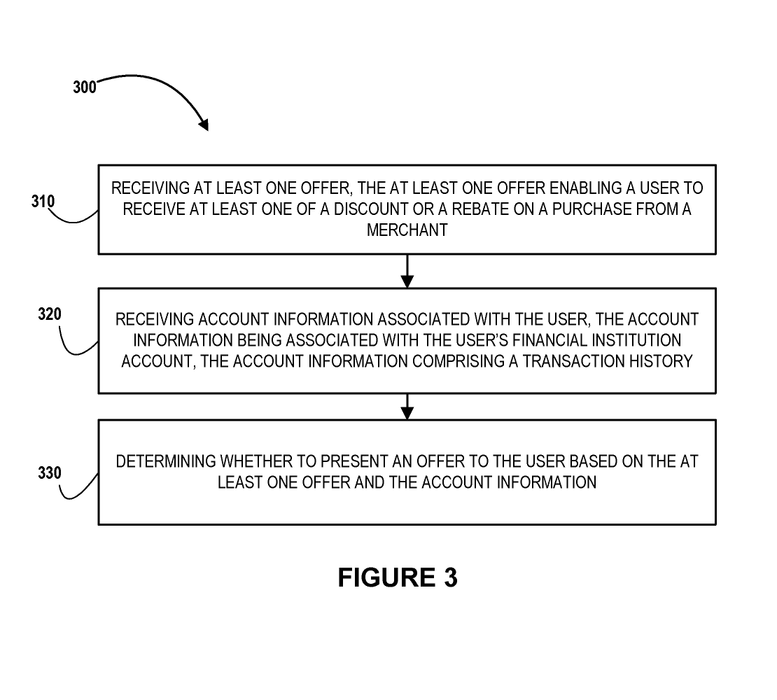

Referring now to FIG. 3, a general process flow 300 is provided for implementing an intelligent offer tool. At block 310, the method comprises receiving at least one offer, the at least one offer enabling a user to receive at least one of a discount or a rebate on a purchase from a merchant. At block 320, the method comprises receiving account information associated with the user, the account information being associated with the user's financial institution account, the account information comprising a transaction history. At block 330, the method comprises determining whether to present an offer to the user based on the at least one offer and the account information. Therefore, the determining step comprises matching an offer to an account (e.g., based on the account information) such that there is a high likelihood (e.g., greater than a threshold probability) that the user associated with the account uses the offer to make a purchase using a payment method associated with the account.

In some embodiments, at block 320, the method further comprises receiving user information associated with the user. The user information includes both account information and personal information associated with the user as described previously with respect to FIGS. 1 and 2. In such embodiments, at block 330, the method comprises determining whether to present an offer to the user based on the at least one offer and the user information.

In some embodiments, the process flow 300 further comprises determining, from the transaction history, whether to exclude a transaction, the excluded transaction being associated with at least one of incorrect, inconsistent, incomplete, or corrupted merchant information or incorrect, inconsistent, incomplete, or corrupted transaction information. Therefore, if a merchant no longer exists, transactions associated with that merchant are excluded. Additionally, if there were inconsistencies in the transaction or merchant information between when the transaction was executed (i.e., when the purchase was made) and when the transaction was processed by the financial institution, such a transaction is excluded as well. Additionally, in some embodiments, an excluded transaction may be a transaction disputed by at least one of the user or the merchant. Excluded transactions are excluded from the process of determining whether to present an offer to a user.

In some embodiments, the system does not exclude a transaction. Instead, the system intelligently determines whether transactions have been incorrectly keyed-in or whether transactions comprise incorrect merchant information. For example, the system intelligently determines that a merchant's name has changed (e.g., from Merchant ‘A’ to Merchant ‘B’), and considers transactions associated with both Merchant ‘A’ and Merchant ‘B’ as being associated with the same merchant. As a further example, the system may determine that a transaction is only partially complete (e.g., missing merchant information or price information, or the like). In such an instance, the system may determine that available information associated with the partially complete transaction is similar to one or more other transactions in the transaction history. In such an instance, the system may add information to the partially complete transaction based on the one or more similar transactions or based on other information provided to the system. As a further example, the system may determine that a transaction may have incorrect information (e.g., a price that is too high or too low, a merchant's name spelled incorrectly, or the like). In such an instance, the system may determine that information associated with the inconsistent or incorrect transaction is similar to one or more other transactions in the transaction history. In such an instance, the system may rectify the inconsistent or incorrect transaction based on the one or more similar transactions or based on other information provided to the system.

In some embodiments, the presented offer is associated with a selected payment method. Exemplary payment methods include paying via a credit card, debit card, personal check, mobile device, or the like. The exemplary payment methods are not limited to those described herein. In some embodiments, the payment method is selected by at least one of the financial institution, the merchant, or the user.

In some embodiments, the offer is presented via at least one of a user interface associated with the user's financial institution account (e.g., online banking account, mobile banking account on a portable mobile communication device, or the like) or a user interface associated with the user's social network account. In some embodiments, the offer is inserted into or presented alongside (e.g., on the right, left, top, bottom side of a transaction, or between multiple transactions) the transaction history that is presented on the user's online banking account or mobile banking account. Therefore, for example, if ten transactions are listed in the transaction history, the offer may be presented between the fourth and fifth transactions. In some embodiments, the offer may be related to the transaction which the offer is presented alongside (e.g., the fourth and/or fifth transaction in the above example). For example, if the fourth transaction is a purchase of item ‘A’ from merchant ‘A,’ the offer is for a purchase of item ‘A’ (e.g., from any merchant) or for a purchase from merchant ‘A’ (e.g., for any item) or for a purchase of item ‘A’ from merchant ‘A.’ Alternatively, the offer may be for a purchase of a substitute of item ‘A’ (e.g., from merchant ‘A’ or from any other merchant). In some embodiments, the offer is transmitted to the user's email account. In other embodiments, the offer is transmitted, via text message, to the user's mobile device.

In some embodiments, the presented offer is an offer to receive at least one of a discount or a rebate on at least one of a purchase previously made by the user (e.g., a previous transaction associated with the user's financial institution account), a purchase from a merchant from which the user previously made a purchase, an alternative to the purchase previously made by the user, or an alternative to the purchase from the merchant from which the user previously made a purchase. The alternative to the purchase may be determined based on transaction histories associated with a plurality of financial institution accounts associated with multiple users.

In some embodiments, the presented offer is an offer to receive at least one of a discount or a rebate on a product or service related to a previous purchase made by the user. For example, if the user previously bought a stove, the offer is a discount or rebate for a dishwasher or a stove maintenance service.

In some embodiments, an offer that is sent to or presented on a financial institution account associated with a first member of a family may be used (or redeemed) by a second member of the family. In some embodiments, the second member of the family may use the offer even if the second member is not associated with the financial institution account associated with the first member. For example, the offer associated with a particular merchant may be transmitted to (or linked to) a credit card account associated with a first family member. When the second member of the family makes a purchase that qualifies for the offer using the second member's credit card (or any other qualifying payment method), the second member receives the rebate after making the purchase. The financial institution may have access to information that indicates that the second member is a family member of the first member even if the second member is not listed as being associated with the financial institution account associated with the first member.

Additionally, in some embodiments, as part of the previously described offer reconciliation process at the time of settlement of the offer, the system determines whether the account information substantially matches the offer information. If the account information has changed since the purchase transaction such that the account information no longer substantially matches the offer information, the offer may be deemed to be invalid and the financial institution does not provide a rebate to the user's financial institution account. However, in other embodiments, even if the account information has changed since the purchase transaction, the offer remains valid and the financial institution provides a rebate to the user's financial institution account.

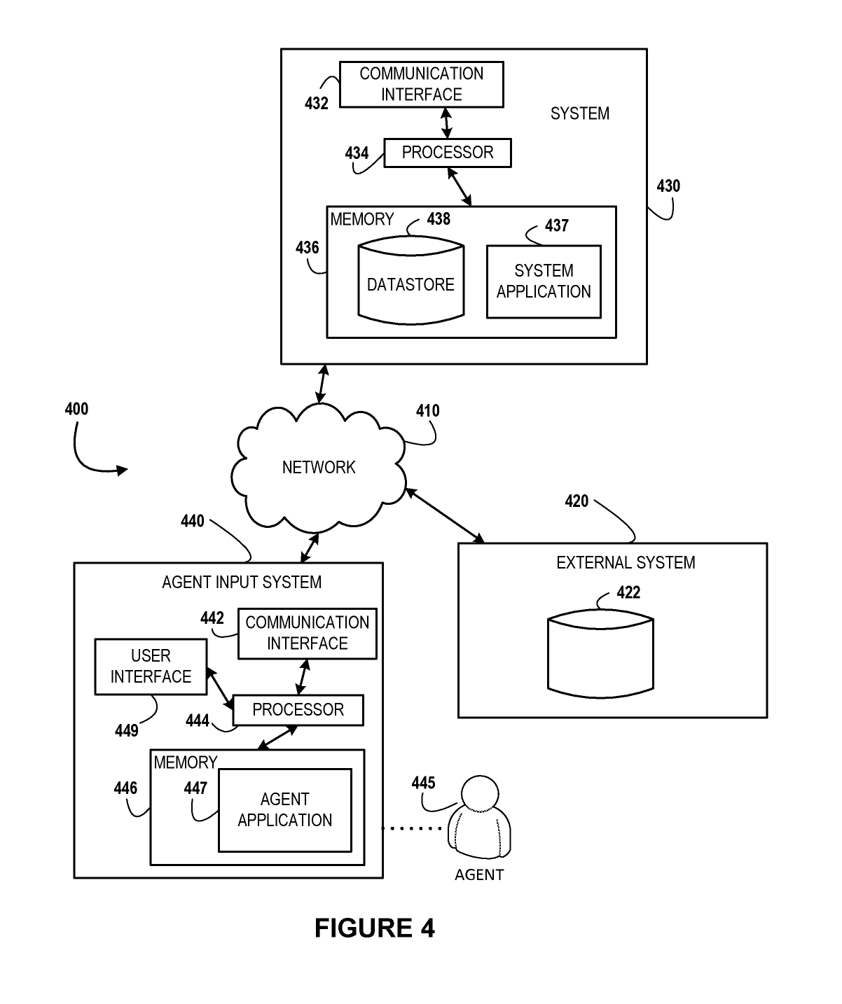

Referring now to FIG. 4, FIG. 4 presents an exemplary block diagram of the system environment 400 for implementing the process flows 100, 200, 300, and 500 described in FIGS. 1, 2, 3, 5, and 6 in accordance with embodiments of the present invention. As illustrated, the system environment 400 includes a network 410, an external system 420, a system 430, and an agent input system 440. Also shown in FIG. 4 is an agent 445 of the agent input system 440. The agent 445 may be a person who uses the agent input system 440 to execute an agent application 447 or uses the agent input system 440 to initiate execution of a system application 437. The agent application 447 and/or the system application 437 may incorporate one or more parts of the process flows 100, 200, and 300. The agent may be an employee of the entity that manages the system 430 and/or the external system 420. In other embodiments, the agent may not be an employee of an entity, but may still provide a service under the direction and/or supervision of the entity. Alternatively, the agent input system 440 may be a user input system associated with a user of a financial institution account as described herein. The features associated with the agent input system 440 are also applicable to the user input system. As described herein, a user input system may be a portable mobile device such as a portable mobile telecommunication device or a portable tablet computer.

As shown in FIG. 4, the external system 420, the system 430, and the agent input system 440 are each operatively and selectively connected to the network 410, which may include one or more separate networks. In addition, the network 410 may include a local area network (LAN), a wide area network (WAN), and/or a global area network (GAN), such as the Internet. The network may also include a mobile telecommunication network. It will also be understood that the network 410 may be secure and/or unsecure and may also include wireless and/or wireline and/or optical interconnection technology.

The external system 420 may be any computing or non-computing system that transmits information to the system 430. Additionally or alternatively, information from the system 430 may be transmitted to the external system 420. As presented in FIG. 4, the external system 420 comprises at least one datastore 422. The datastore 422 may comprise information relating to at least one of the user, the user's financial institution account, offers, rules related to targeting offers to users, personal information, or the like. As used herein, the terms “data” and “information” may be used interchangeably.

The agent input system 440 may include any computerized apparatus that can be configured to perform any one or more of the functions of the agent input system 440 described and/or contemplated herein. For example, the agent 445 may use the agent input system 440 to transmit and/or receive information or commands to and from the system 430. In some embodiments, for example, the agent input system 440 may include a personal computer system, a mobile computing device, a mobile phone, a personal digital assistant, a network device, a mobile phone, and/or the like. As illustrated in FIG. 4, in accordance with some embodiments of the present invention, the agent input system 440 includes a communication interface 442, a processor 444, a memory 446 having an agent application 447 stored therein, and an agent interface 449. In such embodiments, the communication interface 442 is operatively and selectively connected to the processor 444, which is operatively and selectively connected to the agent interface 449 and the memory 446. In some embodiments, the agent 445 may use the agent application 447 to execute processes described with respect to the process flows described herein, or may initiate the system 430 to execute the process flows described herein.

Each communication interface described herein, including the communication interface 442, generally includes hardware, and, in some instances, software, that enables the agent input system 440, to transport, send, receive, and/or otherwise communicate information to and/or from the communication interface of one or more other systems on the network 410. For example, the communication interface 442 of the agent input system 440 may include a modem, transceiver, server, electrical connection, and/or other electronic device that operatively connects the agent input system 440 to another system such as the system 430. A transceiver may include radio circuitry for wirelessly transmitting and receive information.

Each processor described herein, including the processor 444, generally includes circuitry for implementing the audio, visual, and/or logic functions of the agent input system 440. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the agent application 447 of the memory 446 of the agent input system 440.

Each memory device described herein, including the memory 446 for storing the agent application 447 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 4, the memory 446 includes the agent application 447. In some embodiments, the agent application 447 includes an interface for communicating with, navigating, controlling, configuring, and/or using at least one of the system 430 or the agent input system 440. In some embodiments, the agent application 447 includes computer-executable program code portions for instructing the processor 444 to perform one or more of the functions of the agent application 447 described and/or contemplated herein. In some embodiments, the agent application 447 may include and/or use one or more network and/or system communication protocols.

Also shown in FIG. 4 is the user interface 449. In some embodiments, the user interface 449 includes one or more output devices, such as a display and/or speaker, for presenting information to the agent 445. In some embodiments, the user interface 449 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the agent 445. In some embodiments, the user interface 449 includes the input and display devices of a personal computer, such as a keyboard and monitor, which are operable to receive and display information.

FIG. 4 also illustrates a system 430, in accordance with an embodiment of the present invention. The system 430 may include any computerized apparatus that can be configured to perform any one or more of the functions of the system 430 described and/or contemplated herein. In accordance with some embodiments, for example, the system 430 may include a computer network, an engine, a platform, a server, a database system, a front end system, a back end system, a personal computer system, and/or the like. In some embodiments, such as the one illustrated in FIG. 4, the system 430 includes a communication interface 432, a processor 434, and a memory 436, which includes a system application 437 and a datastore 438 stored therein. As shown, the communication interface 432 is operatively and selectively connected to the processor 434, which is operatively and selectively connected to the memory 436.

It will be understood that the system application 437 may be configured to implement any one or more portions of the various user interfaces and/or process flow described herein. It will also be understood that, in some embodiments, the memory includes other applications. It will also be understood that, in some embodiments, the system application 437 is configured to communicate with the datastore 438, the agent input system 440 and/or the external system 420.

It will be further understood that, in some embodiments, the system application 437 includes computer-executable program code portions for instructing the processor 434 to perform any one or more of the functions of the system application 437 described and/or contemplated herein. In some embodiments, the system application 437 may include and/or use one or more network and/or system communication protocols.

In addition to the system application 437, the memory 436 also includes the datastore 438. As used herein, the datastore 438 may be one or more distinct and/or remote datastores. In some embodiments, the datastore 438 is not located within the system and is instead located remotely from the system. In some embodiments, the datastore 438 stores information or data described herein. For example, the datastore 438 may store information relating to at least one of the user, the user's financial institution account, offers, rules related to targeting offers to users, personal information, or the like.

It will be understood that the datastore 438 may include any one or more storage devices, including, but not limited to, datastores, databases, and/or any of the other storage devices typically associated with a computer system. It will also be understood that the datastore 438 may store information in any known way, such as, for example, by using one or more computer codes and/or languages, alphanumeric character strings, data sets, figures, tables, charts, links, documents, and/or the like. Further, in some embodiments, the datastore 438 may include information associated with one or more applications, such as, for example, the system application 437. It will also be understood that, in some embodiments, the datastore 438 provides a substantially real-time representation of the information stored therein, so that, for example, when the processor 434 accesses the datastore 438, the information stored therein is current or substantially current.

It will be understood that the embodiment of the system environment illustrated in FIG. 4 is exemplary and that other embodiments may vary. As another example, in some embodiments, the system 430 includes more, less, or different components. As another example, in some embodiments, some or all of the portions of the system environment 400 may be combined into a single portion. Likewise, in some embodiments, some or all of the portions of the system 430 may be separated into two or more distinct portions.

In addition, the various portions of the system environment 400 may be maintained for and/or by the same or separate parties. For example, the system 430 and the external system 420 may be maintained by separate parties.

It will also be understood that the system 430 may include and/or implement any embodiment of the present invention described and/or contemplated herein. For example, in some embodiments, the system 430 is configured to implement any one or more of the embodiments of the process flow 100, 200, 300, and 500 described and/or contemplated herein in connection with FIGS. 1, 2, 3, 5, and 6 or any other process flow described herein.

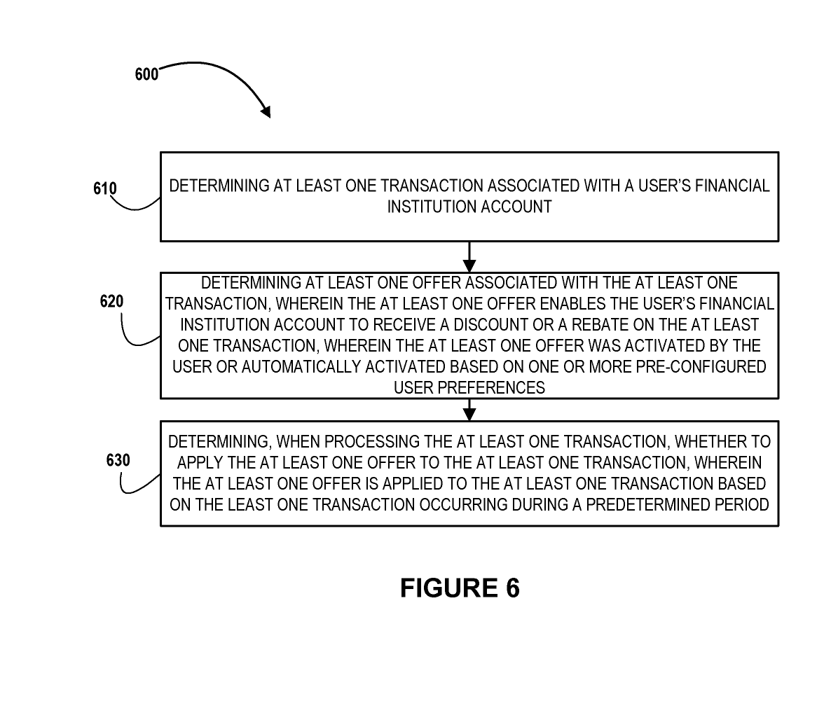

Referring now to FIG. 6, a general process flow 600 is provided for applying an offer to a transaction when processing the transaction, i.e., at settlement time. At block 610, the method comprises determining at least one transaction associated with a user's financial institution account. At block 620, the method comprises determining at least one offer associated with the at least one transaction, wherein the at least one offer enables the user's financial institution account to receive a discount or a rebate on the at least one transaction, wherein the at least one offer was activated by the user or automatically activated based on one or more pre-configured user preferences. At block 630, the method comprises determining, when processing the at least one transaction, whether to apply the at least one offer to the at least one transaction, wherein the at least one offer is applied to the at least one transaction based on the least one transaction occurring during a predetermined period. Processing a transaction and/or an offer may also be referred to as settling a transaction and/or an offer. As explained herein, in some embodiments, either an offer or a substitute of the offer (when a substitution condition is satisfied) may be applied to the transaction at settlement.

An offer may specify that the user will receive the discount or rebate on a purchase transaction if the user executes a purchase transaction between 4 PM and 6 PM on a particular day. The time frame during which the transaction needs to be executed by the user may be defined by the merchant or the financial institution. Therefore, at settlement of the offer, which may occur a predetermined period after occurrence of the transaction, the system described herein determines whether the user executed a purchase transaction between 4 PM and 6 PM on the particular day. The system described herein can determine a time (hour, minute, second) and date associated with a transaction.

In some embodiments, the offer may specify that the user will receive a 5% discount if the user executes a purchase transaction between 10 AM and 6 PM on a particular day, and the user will receive an additional 5% discount if the user executes a purchase transaction between 4 PM and 6 PM on the particular day. Therefore, if the user executes a transaction between 4 PM and 6 PM on the particular day, multiple offers are applied to the transaction at settlement. Thus, at settlement, a plurality of offers may be applied to a single transaction.

In some embodiments, the offer may specify that the user will receive a 5% discount if the user is one of the first five hundred users who execute a purchase transaction between 4 PM and 6 PM on the particular day. At settlement, the system described herein receives transaction information associated with all users who executed a purchase transaction between 4 PM and 6 PM on the particular day, and determines whether the user is among the first five hundred users. If the user is not among the first five hundred users, the user does not receive a rebate or discount, and the system described herein may transmit a message to the user indicating that the user did not receive a rebate or discount because the user was not among the first five hundred users.

In some embodiments, at settlement, the at least one offer is applied to the at least one transaction based on an amount associated with the at least one transaction being greater than a predetermined amount. For example, the offer may specify that the user will receive a discount or rebate on a purchase transaction if the user executes a purchase transaction greater than a predetermined amount (e.g., $10). As a further example, the offer may specify that the user will receive a first discount or rebate (e.g., 5% off) if the user executes a purchase transaction greater than a first predetermined amount (e.g., $10), and the user will receive another discount or rebate (e.g., an additional 5% off) if the user executes a purchase transaction greater than a second predetermined amount (e.g., $25). In some embodiments, the additional discount or rebate is applied only to the difference between the first and second predetermined amounts (e.g., $15), while in other embodiments, the additional discount or rebate is applied to the entire purchase amount (e.g., $25). In some embodiments, the predetermined amount may vary from a first user to a second user, wherein the first user and the second user are associated with the same financial institution account or are associated with different financial institution accounts.

In some embodiments, the at least one transaction comprises a plurality of transactions, and the at least one offer is applied to an aggregate of the plurality of transactions. For example, the offer may specify that the user will receive the discount or rebate on all purchase transactions executed by the user between 4 PM and 6 PM on a particular day. Therefore, at settlement, the system described herein determines all transactions executed by the user between 4 PM and 6 PM on the particular day, and aggregates or adds up the transactions. Then the system applies the at least one offer to the aggregated amount. In some embodiments, some of the transactions executed by the user between 4 PM to 6 PM may be excluded (e.g., transactions that do not meet the minimum amount, transactions executed with a payment method that does not qualify for the offer, transactions executed by a user in the household who does not qualify for the offer, or the like).

In some embodiments, the at least one transaction comprises a transaction associated with the highest transaction amount. For example, the offer may specify that the user will receive the discount or rebate on the transaction associated with the highest amount executed between 4 PM and 6 PM on a particular day. Therefore, at settlement, the system described herein determines transactions executed between 4 PM and 6 PM on a particular day, and selects the transaction associated with the highest amount. Additionally, the system determines whether the selected transaction is excluded based on any exclusion rules described herein. If the selected transaction is not excluded, the at least one offer is applied to the selected transaction. If the selected transaction is excluded, the system determines the transaction associated with the next highest amount, and the at least one offer is applied to the selected transaction.

In some embodiments, the offer is applied to the first (or second, or third, or the like) transaction greater than a predetermined amount (and/or less than a second predetermined amount) after the user activated the offer. In other embodiments, the offer is applied to the largest transaction on the first day (or other predetermined period such as a particular second, minute, hour, day, week, month, or the like) when the user makes a transaction after activating the offer. Therefore, for example, the user activates an offer on Monday. On Wednesday morning, the user executes a $10 transaction that qualifies for the offer. On Wednesday evening, the user executes a $20 transaction that qualifies for the offer. In this example, the offer is applied to the $20 transaction, and not to the $10 transaction. In some embodiments, the date of a transaction is the date when a user executes the transaction. In other embodiments, the date of a transaction is the date when the merchant settles or processes the transaction.

In some embodiments, the offer is applied to a partial portion of a purchase transaction. Therefore, some goods and/or services that are part of the purchase transaction qualify for the offer, while other goods and/or services that are part of the purchase transaction do not qualify for the offer and are consequently excluded. For example, the offer may specify that the offer excludes certain types of goods (e.g., electronics, goods over $500, or the like). Therefore, the offer may be applied to an aggregate of the goods and/or services that qualify for the offer, and may not be applied to an aggregate of the goods and/or services that do not qualify for the offer.

In some embodiments, the user comprises a plurality of users, e.g., a first user and a second user. The plurality of users may comprise a family or a household (e.g., husband, wife, and kids). Therefore, the offer may specify that the user will receive a discount or rebate on transactions executed between 4 PM and 6 PM on a particular day. At settlement, the system described herein determines transactions associated with the first user executed between 4 PM and 6 PM on the particular day and determines transactions associated with the second user executed between 4 PM and 6 PM on the particular day. Therefore, at settlement, the system may aggregate the first user's transactions and the second user's transactions, and apply the at least one offer to the aggregate. The transactions executed by the first user and the second user may be associated with a single financial institution account. The first user and the second user may have executed their transactions using the same or different payment methods (e.g., debit card, credit card, electronic funds transfer, mobile device payment, physical check, or the like). In some embodiments, some of the users associated with the financial institution account may be excluded from the offer. For example, the user's child is excluded from making a purchase transaction associated with certain offers. Therefore, any purchase transactions associated with excluded users are not considered when determining the rebate or discount amount to be applied to the user's financial institution account.

In some embodiments, the at least one transaction comprises a first transaction associated with a first merchant and a second transaction associated with a second merchant. Therefore, at settlement, the offer is applied to a first transaction associated with a first merchant that was executed during a predetermined period (e.g., 4 PM to 6 PM on a particular day) as specified by the offer, and is also applied to a second transaction associated with a second merchant that was executed during the same predetermined period specified by the offer.

In some embodiments, at settlement, the system determines a payment method (e.g., credit card, debit card, electronic funds transfer, mobile device payment, physical check, or the like) associated with the transaction. If the payment method qualifies as an accepted payment method as defined by offer information associated with the offer (defined by at least one of the merchant or the financial institution), the rebate or discount associated with the offer is applied to the user's financial institution account.

When the rebate or discount is applied to the user's financial institution account, the system described herein may transmit a message to the user (e.g., text message, email, social networking message, or the like) indicating the amount of rebate or discount applied to the user's financial institution account. The message may indicate how the rebate or discount amount is calculated (e.g., which transactions were considered, which transactions were excluded, or the like). When a rebate or discount associated with an activated offer is not applied to the user's financial institution account, the system may transmit a message to the user indicating the reasons why the rebate or discount is not applied to the user's financial institution account (e.g., a user associated with the transaction may be excluded, a payment method associated with the transaction may be excluded, an amount associated with the transaction may be smaller than the minimum amount required to qualify for the offer, or the like).

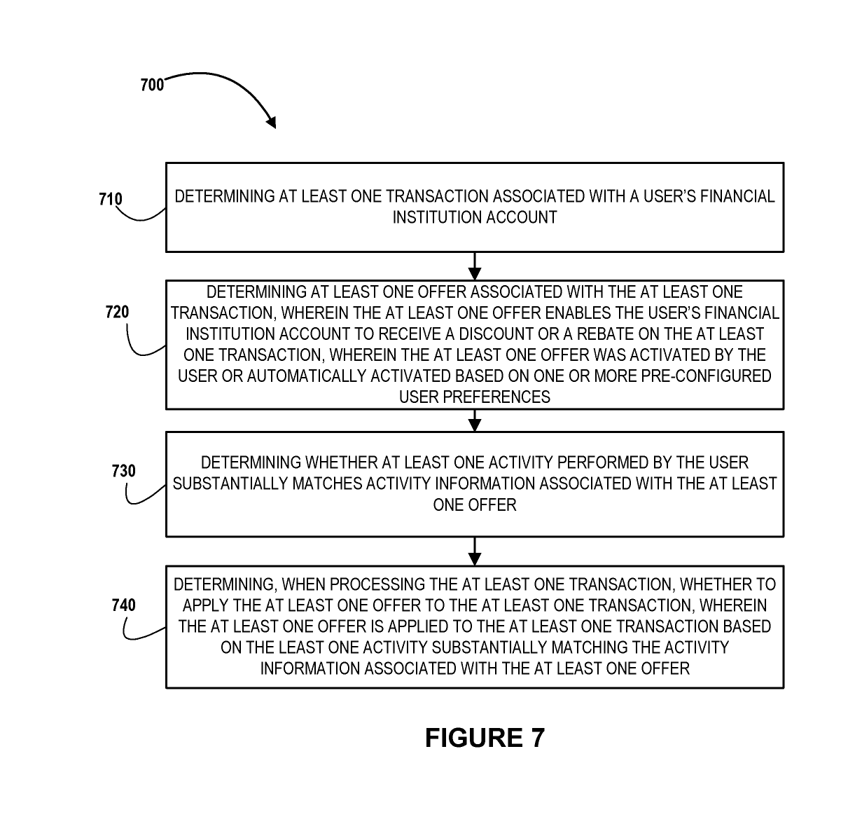

Referring now to FIG. 7, a general process flow 700 is provided for applying an offer to a transaction when processing the transaction, i.e., at settlement time. At block 710, the method comprises determining at least one transaction associated with a user's financial institution account. At block 720, the method comprises determining at least one offer associated with the at least one transaction, wherein the at least one offer enables the user's financial institution account to receive a discount or a rebate on the at least one transaction, wherein the at least one offer was activated by the user or automatically activated based on one or more pre-configured user preferences. At block 730, the method comprises determining whether at least one activity performed by the user substantially matches activity information associated with the at least one offer. At block 740, the method comprises determining, when processing the at least one transaction, whether to apply the at least one offer to the at least one transaction, wherein the at least one offer is applied to the at least one transaction based on the least one activity substantially matching the activity information associated with the at least one offer. Processing a transaction and/or an offer may also be referred to as settling a transaction and/or an offer. As explained herein, in some embodiments, either an offer or a substitute of the offer (when a substitution condition is satisfied) may be applied to the transaction at settlement.

In some embodiments, the at least one activity comprises an activity associated with a social network (uploading a photo, linking the user's social network account to a merchant's social network account, or the like). For example, the offer specifies that the user will receive, at settlement, a 10% discount or rebate on a purchase transaction if the user performs an activity specified by the offer. In this example, the user does not receive a discount or rebate on the purchase transaction if the user does not perform the activity specified by the offer.

As a further example, the offer transmitted to the user specifies that the offer is a 10% discount or rebate offer on a purchase transaction. The offer additionally specifies that if the user broadcasts a certain message (or performs any other specified activity) on a certain social network at a certain time, the user will receive an additional 10% off on the transaction if the user successfully performs the activity specified by the offer. The buzz caused by the coordinated activity of several users substantially simultaneously broadcasting the message improves the brand exposure of a merchant associated with the offer.

Activity information associated with the at least one offer specifies a type of activity and a time period for performing the activity. For example, the offer specifies that the activity comprises posting a message on a social networking interface of the user, the merchant, or the like. As a further example, the activity may comprise posting or uploading a picture (or any electronic object or data) associated with a particular product or service on a social network. As a further example, the activity may comprise posting (or uploading) a message or any electronic object or data (e.g., a picture) on a social networking interface and tagging the message with a tag specified by the offer. As a further example, the activity may comprise linking the user's social networking account to another social networking account (e.g., the merchant's social networking account). The message to be posted by the user may be specified by the offer. For example, the message may be related to the offer, the merchant, or the like. The offer may specify that the message needs to be posted by the user on a particular date at a particular time (e.g., on December 17 between 5 PM and 5:05 PM).

For example, the offer specifies that the user needs to post a certain message associated with a certain hash tag on Twitter® on December 17 between 5 PM and 5:05 PM. When a plurality of users post the message associated with the certain hash tag, a trend associated with the offer (or the merchant associated with the offer) may be generated. This trend may be viewed by other users around the world and consequently improves exposure of the offer and/or the merchant. Other users who view the trend may decide to make a purchase transaction associated with the merchant. Alternatively, other users who view the trend may take steps to receive the offer associated with the merchant (e.g., by filling out a form on the merchant's website or on the merchant's social networking interface). As used herein, a hashtag is utilized to mark keywords or topics in a message. Therefore, the hashtag enables categorization of messages.

As another example, the offer specifies that the user needs to select an option to “like” a certain Facebook® page (e.g., associated with the merchant) on December 17 between 5 PM and 5:05 PM. This activity may be viewed by other social network users who are connected to the user. These other social network users may be directly connected to the user or may be indirectly connected to the user via one or more other users. These other social network users may view the user's activity and decide to make a purchase transaction associated with the merchant. Alternatively, these other social network users may take steps to receive the offer associated with the merchant (e.g., by filling out a form on the merchant's website or on the merchant's social networking interface).

In some embodiments, the at least one offer is applied to the at least one transaction based on a number of social network connections associated with the user's social network account. For example, the user's financial institution account receives the rebate or discount if the user's social network account is connected to more than the predetermined number of other users (e.g., more than 100 other users) at the time of performing the activity (and/or at a predetermined period before and/or after performing the activity). In some embodiments, the system described herein determines whether the user's social network account is connected to more than the predetermined number of other users prior to transmitting the offer to the user. Therefore, if the user is not connected to more than the predetermined number of users, the at least one offer is not transmitted to the user.

In some embodiments, the amount of rebate or discount received by the user's financial institution account is based on the number of social network connections associated with the user's social network account at the time of performing the activity (and/or at a predetermined period before and/or after performing the activity). For example, the amount of the discount or rebate associated with the offer increases based on the number of social network connections associated with the user. For example, a first user who is connected to fifty other users on the social network receives a 5% discount or rebate on the purchase transaction, while a second user who is connected to one hundred other users on the social network receives a 10% discount or rebate on the purchase transaction. Additionally, the system may determine whether the user's activity was broadcasted to the user's social network connections. The user receives the discount or rebate on the purchase transaction if the user's activity was broadcasted to the user's social network connections. If the system determines that the user's activity was not broadcasted to the user's social network connections (e.g., based on the user's social network account settings), the user does not receive the discount or rebate on the purchase transaction.

In some embodiments, the specified activity is a physical activity, and not an activity on a social network. For example, the activity may comprise mailing a letter (e.g., a letter including the offer) to the merchant or the financial institution. As a further example, the activity may comprise the user traveling to certain location. In such embodiments, the user's mobile device may determine its own location using a global positioning system (GPS) system embedded within the mobile device, and automatically transmit the user's location to the system described herein.

At settlement, the system receives information regarding the user's performance of the activity. In some embodiments, the system receives information from a system associated with the merchant or the social network. In other embodiments, the system receives information from the user (or from the user's mobile device) regarding the user's performance of the activity.

In some embodiments, after the system determines that the user performed the activity specified by the offer, and after calculating the discount or rebate to be applied to the user's financial institution account, the system is configured to notify the user that the user successfully performed the activity specified by the offer and is configured to notify the user of the resulting rebate or discount as a result of successfully performing the activity. In some embodiments, the system is configured to notify the user that the user did not successfully perform the activity specified by the offer, and is configured to notify the user of the resulting rebate or discount, if any, as a result of not successfully performing the activity. In some embodiments, the notification also includes the reasons why the user did not successfully perform the activity specified by the offer (e.g., the user did not post the specified message on the social network, the user did not post the specified message at the specified time, or the like).

In some embodiments, the system is configured to receive information associated with a user activity. For example, the system is configured to receive information associated with television activity associated with a television in the user's home, car, or the like. The television may be connected to a network from which the system described herein receives information. For example, the system receives information regarding which television programs are frequently watched by the user, which television channels are frequently watched by the user, which advertisements are watched by the user, which advertisements are skipped (e.g., the user changes channel), which television programs are frequently recorded by the user, or the like. For example, the system receives information regarding the user watching (and not skipping or changing the channel) an electronics merchant's advertisement that is displayed simultaneously during a television program or that is displayed during an advertisement intermission associated with the television program. As a further example, the system receives information regarding when during the advertisement (e.g., how many seconds after the start of the advertisement) that the user selected an option to skip the advertisement or change the channel. As a further example, the system receives information regarding the user skipping a fast food advertisement or changing the channel when the fast food advertisement is displayed. As a further example, the user receives information regarding the user executing a search on the user's computing device associated with a merchant or a product or service displayed in a television advertisement, wherein the television may or may not be separate from the computing device. The user may select an option to share or not share information associated with the user's television activity.

As a further example, the system may be configured to receive network activity associated with the user. For example, the system may be configured to receive information associated with a search conducted by the user on a search engine on a computing device. For example, the system may receive the user's search terms, search history, search result websites visited by the user, or the like. As a further example, the system may be configured to receive information associated with a social network. For example, as described herein, the system may be configured to receive information associated with the user's posts on Twitter®. Posts may include messages, pictures, or other electronic objects or data. As a further example, the system may be configured to receive information associated with the user's messages, “likes,” or the like, on Facebook®. Therefore, the system may receive information regarding merchants “liked” by the user on Facebook®. Any activity associated with the user on the social network may also include an activity associated with the user' social network connection. Therefore, the system may receive information regarding merchants “liked” by the user's social network connection. The system may receive network information associated with the user from the website visited by the user, the computing device being used by the user to access the website, or the like. The user may select an option to share or not share information associated with the user's network activity.

In some embodiments, an activity performed by the user may include an activity performed by a user's friend, family member, or social network connection. The television or the computing device described herein may be configured to transmit information regarding the activity to the system in substantially real-time while the activity is taking place. Alternatively or additionally, the information may be transmitted to the system a predetermined period after occurrence of the activity.

As a further example, the system may be configured to receive information regarding an activity performed by the user in the physical world. For example, the user activity may comprise the user traveling to a location (e.g., a movie theater). As a further example, the user activity may comprise the user visiting a local gym every few days. Information regarding the user activity may be transmitted from the mobile device to the system described herein while the activity is occurring or a predetermined period after occurrence of the activity. Alternatively, the user may transmit information regarding the user's activity to the system either prior to, during, or after occurrence of the activity.

As described herein, the system is configured to transmit an offer to a user based on at least one of account information or user information associated with a user. Additionally or alternatively, the system may be configured to transmit an offer to the user based on the user activity described herein. For example, when the user is watching a football game on a television, the system may be configured to transmit a beverage offer to the user. As a further example, when the user searches for the term “refrigerator” on the user's computing device, the system may be configured to transmit refrigerator offers to the user. As a further example, when the user visits a movie theater, the system may be configured to transmit offers associated with purchasing movie tickets to the user. The system may be configured to transmit an offer to the user substantially simultaneously with, immediately following, or a predetermined period after occurrence of the user activity. For example, when the user is watching an electronics merchant's advertisement on television, an offer associated with the electronics merchant is transmitted to the user via text message, email, social networking message, or the like. The user may choose to activate or reject the offer. Therefore, for example, if the user is using a computing device while watching the television advertisement, the offer is displayed (e.g., as a pop-up message) on the computing device. As used herein, the computing device and the television may either be separate devices or part of the same device (e.g., same housing). Additionally or alternatively, the system may be configured to transmit or present an offer to the user a predetermined period after occurrence of the user activity. Therefore, for example, when the user logs into the user's financial institution account or social networking account following occurrence of the activity, the offer associated with the electronics merchant is presented to the user. As a further example, the offer is transmitted to the user via text message, email, social networking message, or the like, a predetermined period after occurrence of the activity.

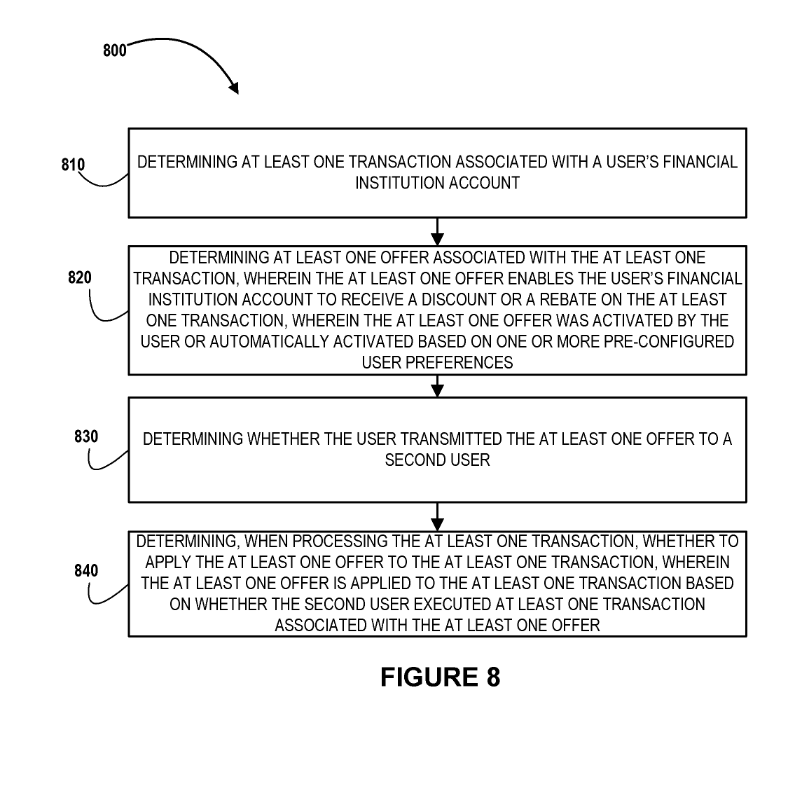

Referring now to FIG. 8, a general process flow 800 is provided for applying an offer to a transaction when processing the transaction, i.e., at settlement time. At block 810, the method comprises determining at least one transaction associated with a user's financial institution account (may also be referred to as “account”). At block 820, the method comprises determining at least one offer associated with the at least one transaction, wherein the at least one offer enables the user's financial institution account to receive a discount or a rebate on the at least one transaction, wherein the at least one offer was activated by the user or automatically activated based on one or more pre-configured user preferences. At block 830, the method comprises determining whether the user transmitted the at least one offer to a second user. At block 840, the method comprises determining, when processing the at least one transaction, whether to apply the at least one offer to the at least one transaction, wherein the at least one offer is applied to the at least one transaction based on whether the user transmitted the at least one offer to the second user and/or whether the second user executed at least one transaction associated with the at least one offer received from the user. Therefore, the invention enables a user to increase the amount of the rebate or discount prior to settlement. Processing a transaction and/or an offer may also be referred to as settling a transaction and/or an offer. As explained herein, in some embodiments, either an offer or a substitute of the offer (when a substitution condition is satisfied) may be applied to the transaction at settlement.

In some embodiments, the offer transmitted to a user may specify that the user's financial institution account will receive a rebate or discount associated with the offer if the user transmits the offer to a predetermined number (e.g., ten users) of other users and/or if at least some of (e.g., 50%) the predetermined number of other users execute a transaction associated with the offer.

The user may transmit the at least one offer to the second user via email, text message, a social network message, or a financial institution network message. For example, when the offer is presented to the user alongside the user's transaction history on the user's financial institution account, the user may select an option to transmit the offer to the second user. If the user transmits the offer to the second user via email or text message, the second user is notified of the offer transmission via email or text message. If the user transmits the offer to the second user via a social network or a financial institution network, the second user is notified of the offer transmission the next time the second user logs into the second user's social network account or financial institution account. Additionally or alternatively, the second user is notified of the offer transmission via email or text message. The second user may select an option to accept or reject the at least one offer. When the second user accepts or rejects the at least one offer, the system is configured to send notification to the user indicating the second user has either accepted or rejected the at least one offer.

In some embodiments, the offer may specify the mode of transmission for transmitting the at least one offer to the second user. For example, the offer may specify that the user may transmit the at least one offer to the second user via a social network. In such embodiments, the user receives a special discount associated with transmitting the at least one offer to the second user if the user transmits the at least one offer via a social network or a financial institution network, and does not receive the special discount associated with the at least one offer if the user transmits the offer via email or text message. In some embodiments, the offer may additionally specify that the user's act of transmitting the offer via a social network needs to be visible to other connections associated with the user's social network. In such embodiments, at settlement, the system receives information regarding whether the user transmitted the at least one offer to the second user via the specified mode of transmission and whether the user's transmission activity was visible to other connections in the user's social network (in embodiments where the user transmits the at least one offer via a social network). If the user's transmission activity was not visible to a predetermined number or percentage of other connections in the user's social network at the time of transmission or a predetermined period following the transmission, the user does not receive the special discount associated with transmitting the offer.

In some embodiments, the system is configured to determine whether the user transmitted the offer to a plurality of other users. Therefore, the discount or rebate on the user's transaction may be determined based on how many other users to whom the user transmitted the offer, regardless of whether or not the other users executed a purchase transaction associated with the offer. For example, the offer may enable the user to receive a 5% discount or rebate on a purchase transaction. If the user transmitted the offer to fifty other users prior to the settlement of the user's purchase transaction, the user would receive an extra 5% discount or rebate on the user's purchase transaction. If the user transmitted the offer to one hundred other users prior to the settlement of the user's purchase transaction, the user would receive an extra 10% discount or rebate on the user's purchase transaction.

In some embodiments, the discount or rebate on the user's transaction may be determined based on at least one of a time period between the user's activation of the offer and the user's transmission of the offer to the second user, a time period between the user's transmission of the offer and the expiration date of the offer, a time period between the second user's execution of a transaction associated with the offer and the expiration date of the offer, a time period between the user's transmission of the offer to the second user and the second user's activation of the offer, a time period between the first user's execution of a transaction associated with the offer and the second user's execution of a transaction associated with the offer, or the like. In some embodiments, when the user transmits the offer to the second user, the expiration date associated with the offer received by the second user may be different from the original offer (e.g., the transmitted offer may have a later expiration date).

In some embodiments, the system is configured to determine the discount the rebate on the at least one transaction based on how many other users who received the offer from the user executed a transaction associated with the offer. For example, the offer may enable the user to receive a 5% discount or rebate on a purchase transaction. If the user transmitted the offer to fifty other users and each of these other users executed a purchase transaction associated with the offer prior to the settlement of the user's purchase transaction, the user would receive an extra 5% discount or rebate on the user's purchase transaction. If the user transmitted the offer to one hundred other users and each of these other users executed a purchase transaction associated with the offer prior to the settlement of the user's purchase transaction, the user would receive an extra 10% discount or rebate on the user's purchase transaction.

In some embodiments, the discount or rebate for the user's transaction is increased (e.g., 0.5%) for every incremental user who receives the offer from the user and/or who executes a transaction associated with the offer prior to settlement of the user's transaction. In some embodiments, the discount or rebate for the user's transaction is increased based on how soon after the user transmits the offer to the incremental user that the incremental user activates the offer and executes a transaction associated with the offer. Therefore, for example, in order for the discount or rebate for the user's transaction to be increased, the system may determine whether the incremental user activated the offer and executed a purchase transaction associated with the offer within a predetermined period (e.g., five days) after receiving the offer from the user. The incremental user executes a purchase transaction associated with an offer received from the user when the incremental user makes a purchase transaction that enables the incremental user's financial institution account to receive a rebate or discount associated with the offer.

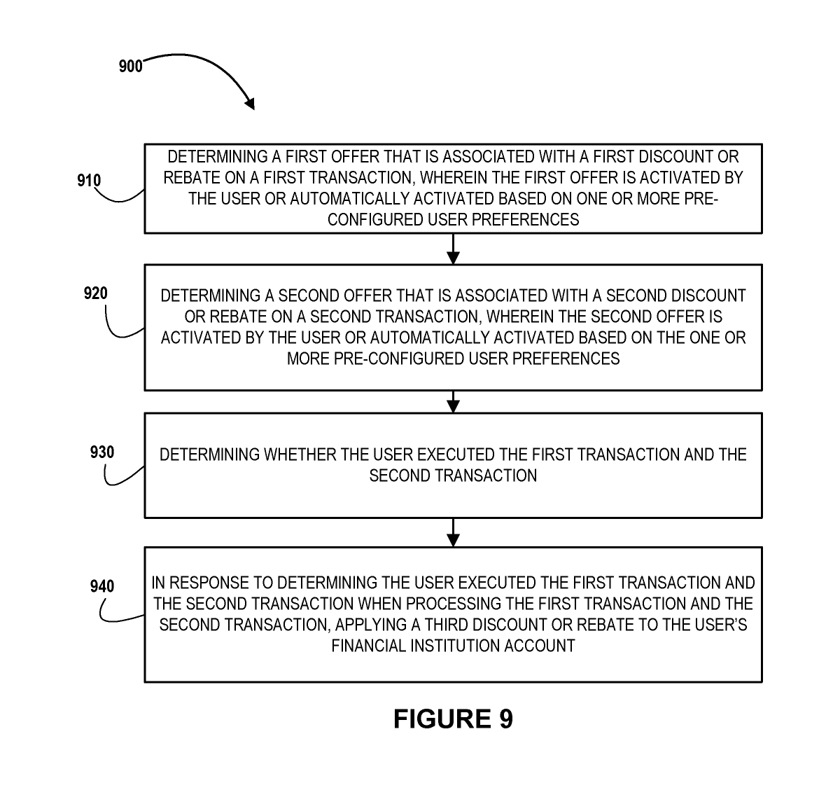

Referring now to FIG. 9, a general process flow 900 is provided for offer aggregation (or offer bundling or packaging) when processing multiple transactions, i.e., at settlement time. At block 910, the method comprises determining a first offer that enables the user's financial institution account to receive a first discount or rebate on a first transaction, wherein the first offer is activated by the user or automatically activated based on one or more pre-configured user preferences. At block 920, the method comprises determining a second offer that enables the user's financial institution account to receive a second discount or rebate on a second transaction, wherein the second offer is activated by the user or automatically activated based on the one or more pre-configured user preferences. At block 930, the method comprises determining whether the user executed the first transaction and the second transaction. At block 940, the method comprises in response to determining the user executed the first transaction and the second transaction when processing the first transaction and the second transaction, applying a third discount or rebate to the user's financial institution account, wherein the third discount or rebate is based on at least one of the first discount or rebate or the second discount or rebate. The third discount or rebate may also be referred to as a special discount or rebate. Therefore, the invention enables a user to increase the amount of the rebate or discount prior to or at settlement. Processing a transaction and/or an offer may also be referred to as settling a transaction and/or an offer. As explained herein, in some embodiments, either an offer or a substitute of the offer (when a substitution condition is satisfied) may be applied to a transaction at settlement.

In some embodiments, the third discount or rebate is applied to the user's account instead of the first discount or rebate and/or the second discount or rebate. In other embodiments, the third discount or rebate is applied to the user's account in addition to the first discount or rebate and/or the second discount or rebate. In some embodiments, the amount of third discount or rebate is calculated based on at least one of the first discount or rebate associated with the first offer, the second discount or rebate associated with the second offer, account information associated with the user (e.g., transaction history, history of relationship with financial institution, or the like), or user information associated with the user (e.g., residence mailing address).

In some embodiments, the first transaction and the second transaction may be associated with different merchants, while in other embodiments, the first and second transactions may be associated with the same merchant. When the first and second transactions are associated with the same merchant, they may be associated with different products or services associated with the merchant. In some embodiments, the first transaction and the second transaction may be executed substantially simultaneously, while in other embodiments, the first transaction and the second transaction are executed in an order communicated to the user by the system described herein or in an order determined by the user.

In some embodiments, the first offer may be associated with a particular discount or rebate (e.g., 10% off on $30 minimum purchase). The second offer may be associated with a greater discount or rebate (e.g. 12% off on $30 minimum purchase). Therefore, each successive transaction executed by the user (or each successive offer presented to the user) may be associated with a greater discount or rebate when compared to the previously executed transaction (or the previously presented offer).

In some embodiments, the first offer (or a message associated with the first offer) may specify that the user will receive the discount or rebate associated with the first offer if the user executes transactions associated with both the first offer and the second offer. In some embodiments, the first offer may specify that the user will receive the discount or rebate associated with the first offer if the user executes transactions associated with both the first offer and the second offer in a predetermined order. In some embodiments, the first offer may specify that the user will receive the discount or rebate associated with the first offer if the user executes transactions associated with both the first offer and the second offer in a predetermined period of time (e.g., five hours for executing transaction associated with the first offer, next five hours for executing transaction associated with second offer, ten hours for executing transactions associated with both the first and second offers, or the like). Additionally, the first offer may specify that the user will not receive the discount or rebate associated with the first offer if the user does not execute transactions associated with both the first offer and the second offer.

In some embodiments, the first offer and the second offer may be associated with a first activity and a second activity on the itinerary. Therefore, the user receives a first discount or rebate if the user completes the first activity associated with the first offer and receives a second discount or rebate if the user completes the second activity associated with the second offer. However, if the user completes both the first activity and the second activity within a predetermined period (e.g., a single day), a third discount or rebate is applied to the user's account. This third discount or rebate may be greater than a sum of the first discount or rebate or the second discount or rebate.

In some embodiments, either after or before the user activates the first offer and the second offer, the system may communicate to the user that the first transaction associated with the first offer and the second transaction associated with the second offer need to be executed in a predetermined order. For example, the system may communicate that the second transaction associated with the second offer may need to be executed on a particular day in the future, and the first transaction associated with the first offer may need to executed on a day after the particular day.

Therefore, the present invention enables a user to increase a discount or rebate associated with one or more offers based on the user executing several purchase transactions (e.g., a first transaction and a second transaction described herein). For example, the system receives information regarding the user's transaction of a rental property in a beach town. Based on this transaction, the system may be configured to transmit or present to the user offers associated with merchants in the beach town that are geographically proximate to the rental property (e.g., a bike rental merchant, a water sports merchant, or the like). Therefore, the invention enables a group of merchants associated with a geographical locality to drive customers to that locality. The system may also communicate to the user that if the user executes purchase transactions associated with a plurality of the offers (e.g., 4 out of the 10 offers presented to the user) within a predetermined period (e.g., a day), the user will receive an extra rebate or discount on the last purchase transaction (or on an aggregate of the purchase transactions executed by the user). For example, if the last purchase transaction executed by the user is a purchase associated with a 5% discount or rebate, the system may apply a 25% discount or rebate to the last transaction. As a further example, if the sum of the rebates or discounts associated with the purchase transactions is $100, the system may instead apply a $200 rebate or discount to the user's financial institution account.

The system may or may not have previously informed the user of the amount of the discount or rebate increase (i.e., the special rebate or discount) applied to the last transaction (or to the aggregate of the purchase transactions). However, at settlement time, the system may communicate to the user the amount of the special rebate or discount and how the special rebate or discount was calculated. The amount of the discount or rebate applied to the last transaction (or to the aggregate of the purchase transactions) may be based on how many offers were activated, how many purchase transactions associated with the presented or activated offers were executed by the user, and the time period within which the purchase transactions were executed. For example, the system may apply a 20% discount or rebate on the last transaction (or on the aggregate of the purchase transactions) if the user executed transactions associated with five out of ten offers presented to the user. As a further example, the system may apply a 40% discount or rebate on the last transaction (or on the aggregate of the purchase transactions) if the user executed transactions associated with eight out of the ten offers presented to the user.

The system may determine whether the user executed the purchase transactions (e.g., the first transaction and the second transaction) associated with the presented offers (e.g., the first offer and the second offer) within a predetermined period. For example, the first offer or the second offer may specify that the user will receive the rebate or discount associated with the last transaction (or associated with the aggregate of the transactions) if the user executed the purchase transactions (or at least a predetermined number of purchase transactions) within a predetermined period (e.g., a day).

As explained herein, the system may be configured to determine the first offer (e.g., merchant associated with offer, expiry date of offer, product or service associated with offer, users associated with an account who can execute transactions associated with offer, minimum purchase amount associated with the offer, or the like) and the second offer based on a purchase transaction that has already occurred (e.g., from the transaction history). In other embodiments, the system may be configured to determine the first offer and the second offer based on purchase transactions that have not yet occurred. Therefore, the system receives information (e.g., from a social network) regarding a purchase transaction to be executed by the user within a predetermined period of time in the future. In other embodiments, the user may pre-declare the user's intent to execute a particular purchase transaction in the future. The user may declare this intention on a social network. Additionally or alternatively, the user may provide this intent directly to merchants that the user is interested in received offers from. Additionally or alternatively, the user may provide this intent directly to the financial institution system described herein. For example, the user may communicate to the financial institution that the user is interested in receiving offers associated with particular offer categories (e.g., water sports, seafood, or the like) associated with a particular locality (e.g., near the user's rental property), associated with particular products or services, associated with a particular time frame, or the like. In other embodiments, the system determines or predicts a purchase transaction to be executed by the user within a predetermined period of time in the future. This prediction may be based on the account information (e.g., transaction history) and/or user information (e.g., change in residence address, social networking information, or the like) described herein. For example, the system may determine, based on the change in the user's residence address, that the user will make a purchase transaction associated with moving services, buying new furniture, or the like. As a further example, the system may determine, based on transaction history associated with recent transactions, that the user is getting ready to remodel the user's kitchen. Therefore, the first offer and the second offer may be related to the remodeling of the user's kitchen. For example, the first offer may be an offer to buy paint, and the second offer may be an offer for cabinet knobs.

In some embodiments, the system receives information associated with an event in the user's life (e.g., the user is expecting the birth of a new kid within the next month). The system may predict the occurrence of this event based on at least one of the account information or the user information described herein. Alternatively or additionally, the user may self-declare the occurrence of this event to the merchant and/or to the financial institution. Therefore, the first offer and the second offer may be based on this event in the user's life.

The first and second offers may be presented to the user via at least one of the user's electronic banking account (e.g., online banking account, mobile banking account on a portable mobile communication device, or the like), the user's social network account, email, or text message. The offers may be presented together (e.g., as thumbnails) such that the user views the offers on the same mobile interface page. Therefore, the first offer and the second offer are presented to the user prior to the user executing transactions associated with at least one of the first offer or the second offer. The first offer and the second offer may be activated by selecting a single option to activate both the first and second offers simultaneously, or may be activated by the user selecting separate options associated with both the first and second offers. Additionally, either prior to displaying the first and second offer or after displaying the first and second offers, the system presents to the user a message that the user will receive a special discount or rebate if the user executes transactions associated with both the first and second offers within a predetermined period of time. As described herein, the special discount or rebate may be applied to the last transaction in a sequence of transactions or may be applied to an aggregate of transactions.

As described herein, an offer (e.g., the first offer or the second offer) may be associated with an offer category. A user may have previously selected options to receive offers associated with certain categories, and not to receive offers associated with other categories. Therefore, the system selects the first offer and the second offer based on offer categories previously approved by the user, and does not select the first offer and the second offer from offer categories not previously approved by the user. Additionally, the first offer and the second offer may be selected either from the same approved offer category or from different approved offer categories. Offer categories may be based on location, type of good or service sold by the merchant, or the like.

In some embodiments, the first offer and/or the second offer may specify that the user will receive a discount or rebate associated with at least one of the first offer or the second offer (or a special discount or rebate as described herein) based on the user completing an activity and/or based on the user transmitting at least one of the first offer or the second offer to another user. For example, the first offer may specify that the user has to complete an activity associated with the first merchant, wherein the activity is independent of (or part of) the transaction. For example, if the first offer is a 15% off offer on a minimum dine-in purchase of $50 at a restaurant, the activity may include purchasing merchandise (e.g., a T-shirt) at the restaurant. The activity may be independent of the user's dine-in purchase at the restaurant. Still additionally, the first offer may specify that the user has to transmit the first offer to a predetermined number of other users (e.g., ten other users), and may additionally specify that a predetermined percentage (e.g., 50%) of the users to whom the offer was transmitted need to execute a transaction associated with the first offer either a predetermined period before or predetermined period after the user executes the transaction associated with the first offer (or within a predetermined period after receiving the first offer from the user). Therefore, a user successfully executes a transaction associated with the first offer if the user completes the activity specified by the first offer and/or transmits the first offer to the predetermined number of other users. At settlement of the first offer, the system may determine whether the predetermined percentage of users who received the first offer from the user executed a transaction associated with the received offer within a predetermined period after receiving the first offer from the user (or within a predetermined period either before or after the user's transaction associated with the first offer).

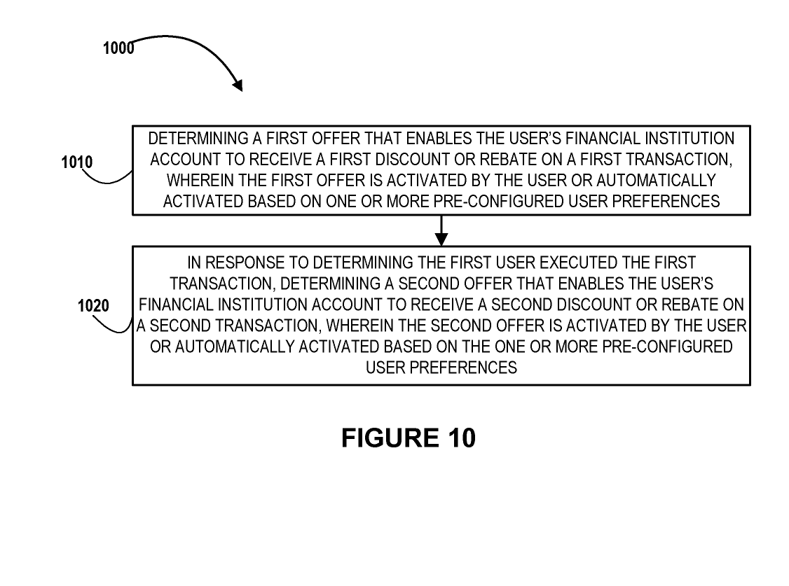

Referring now to FIG. 10, a general process flow 1000 is provided for sequential offer aggregation. At block 1010, the method comprises determining a first offer that enables the user's financial institution account to receive a first discount or rebate on a first transaction, wherein the first offer is activated by the user or automatically activated based on one or more pre-configured user preferences. At block 1020, the method comprises in response to determining the user executed the first transaction, determining a second offer that enables the user's financial institution account to receive a second discount or rebate on a second transaction, wherein the second offer is activated by the user or automatically activated based on the one or more pre-configured user preferences. Therefore, the invention enables a user to sequentially receive offers and execute transactions associated with the offers. The invention enables conversion of the offer transmission or presentment process to a game such that the user engages in a “treasure hunt” or “scavenger hunt” in order to discover merchants in a particular geographical locality and execute transactions associated with offers provided by those merchants. Therefore, the invention enables the user to explore a geographical locality. Features described with respect to any of the other process flows (e.g., process flow 900 in FIG. 9) may also be applicable to the process flow in FIG. 10.

Processing of transactions associated with the offers does not occur until a predetermined period in the future when a batch processing operation is executed (e.g., monthly generation of account statements). As used herein, processing a transaction and/or an offer may also be referred to as settling a transaction and/or an offer. As explained herein, in some embodiments, either an offer or a substitute of the offer (when a substitution condition is satisfied) may be applied to a transaction at settlement. Therefore, the user receives rebates associated with the offers (e.g., the first offer and the second offer) at settlement. If the transactions associated with both the first and second offers are settled during the same batch processing operation, the user receives rebates associated with both transactions at the conclusion of that batch processing operation.

For example, the system receives information regarding a user's hotel reservation in uptown Charlotte. Alternatively, the system determines or predicts that the user will or intends to make a hotel reservation in uptown Charlotte at a predetermined time in the future. The system then transmits a first offer to the user based on at least one of account information (e.g., the hotel reservation or predicted hotel reservation) or user information associated with the user. The first offer may be a 10% off offer on a $30 minimum purchase at a merchant in uptown Charlotte. The first offer may not specify at least one of the name or the location of the merchant in uptown Charlotte; therefore, the first offer may also be referred to as a mystery offer. Instead, the first offer may include a clue. The clue may be associated with at least one of the name or the location of the merchant in uptown Charlotte. For example, the clue might state “Go to where the cats run.” The user may interpret the clue as the Carolina Panthers stadium. Additionally or alternatively, the clue may include a map that indicates the location of the merchant. Additionally, the offer may specify that that the transaction needs to be executed within a predetermined period of time (e.g., two hours). When the user goes to the Carolina Panthers stadium and executes a transaction associated with the first offer, information regarding the user's transaction may be transmitted to the system described herein. The system may receive information regarding the transaction either from the merchant or from the user. If the system determines that the user successfully executed a transaction associated with the first offer, the system may transmit a second offer to the user. Therefore, the user has no knowledge what the second offer will be (and whether the user will receive the second offer) until the user successfully completes a transaction associated with the first offer. As described herein, a user successfully executes a transaction associated with the first offer if the user made a transaction greater than the predetermined minimum amount (e.g., $30) at the correct merchant and within the predetermined period of time (e.g., 2 hours from the receipt of the first offer).

Additionally, in some embodiments, the first offer may specify that the user has to complete an activity associated with the merchant (e.g., attending a football game at the Carolina Panthers stadium, finding a secret prize at or near the location of the merchant, or the like), wherein the activity is independent of (or part of) the transaction. For example, the transaction may be the purchase of a ticket to attend the football game. Additionally or alternatively, the first offer may specify that the user has to transmit the first offer to a predetermined number of other users (e.g., ten other users), and may additionally specify that a predetermined percentage (e.g., 50%) of the users to whom the offer was transmitted need to execute a transaction associated with the first offer either a predetermined period before or predetermined period after the user executes the transaction associated with the first offer (or within a predetermined period after receiving the first offer from the user). Therefore, a user successfully executes a transaction associated with the first offer if the user completes the activity associated with the merchant and/or transmits the first offer to the predetermined number of other users. At settlement of the first offer, the system may determine whether the predetermined percentage of users who received the first offer from the user executed a transaction associated with the received offer within a predetermined period of receiving the first offer from the user (or within a predetermined period either before or after the user's transaction associated with the first offer).

In some embodiments, the offer (e.g., the first offer or the second offer) is associated with a puzzle comprising a clue to a location of a merchant associated with the offer. Therefore, the clue may comprise information regarding the name of the merchant, the location of the first merchant, directions to the merchant, or the like. Additionally, the offer may be associated with a map. The user may use the map to find the location of the merchant. The clue and the map may be presented on the user interface of the user's mobile device.

In some embodiments, the second puzzle is more complex compared to the first puzzle. Therefore, the second puzzle is designed to take longer for an average user to solve and find the merchant associated with the second offer. The second puzzle may be designed to be more complex because a discount or rebate associated with the second offer may be greater than a discount or rebate associated with the first offer. Therefore, each successive offer presented to the user after the user successfully executes a transaction associated with a previously presented offer may be more complex than the previously presented offer and may be associated with a larger discount or rebate compared to the previously presented offer.

Similar to the first offer, the second offer transmitted to the user may be based on at least one of account information (e.g., the hotel reservation or predicted hotel reservation) or user information associated with the user. Additionally or alternatively, the second offer may be based on the first offer. For example, the second offer may be associated with a merchant located geographically proximate to the merchant associated with the first offer. As a further example, the second offer may be associated with a merchant category (e.g., restaurant category) similar to or the same as that associated with the first offer. Additionally, since the user successfully executed the transaction associated with the first offer, the rebate or discount amount associated with the second offer may be greater than that associated with the first offer. For example, the second offer may be a 20% off offer on a $30 minimum purchase at a merchant. In some embodiments, the merchant associated with the second offer may be the same as or different from the merchant associated with the first offer. If the merchant is the same as the merchant associated with the first offer, the second offer may be an offer associated with a different product or service compared to that associated with the first offer.

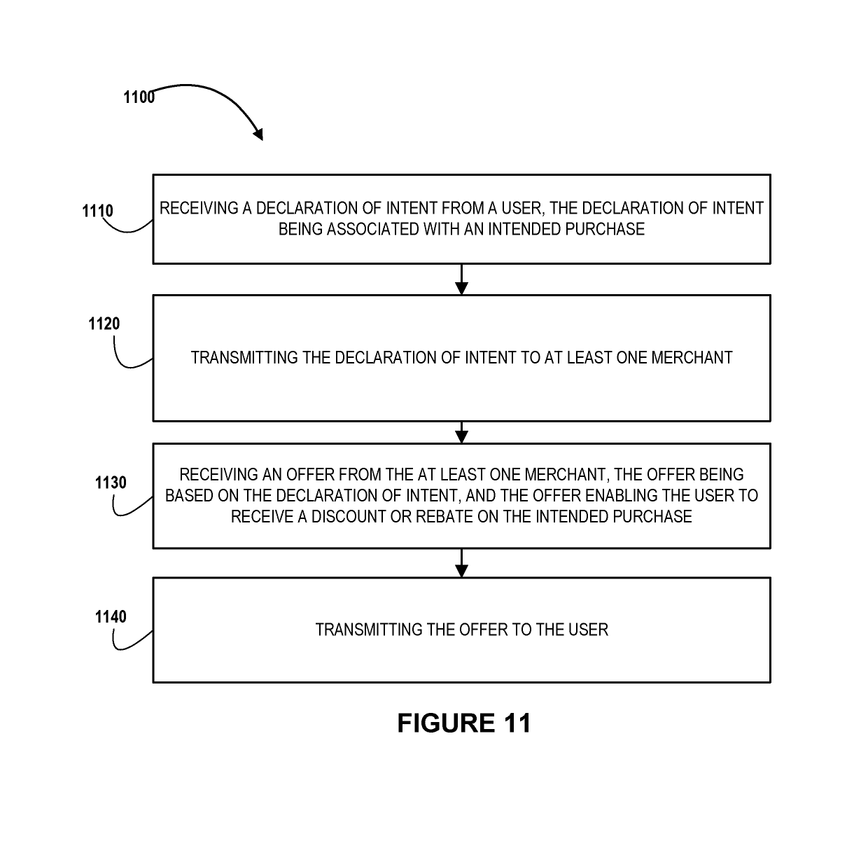

Referring now to FIG. 11, a general process flow 1100 is provided for transmitting offers based on pre-purchase intent. At block 1110, the method comprises receiving a declaration of intent or interest from a user, the declaration of intent being associated with an intended purchase. At block 1120, the method comprises transmitting the declaration of intent to at least one merchant. At block 1130, the method comprises receiving an offer from the at least one merchant, the offer being based on the declaration of intent, and the offer enabling the user to receive a discount or rebate on the intended purchase. At block 1140, the method comprises transmitting the offer to the user. The invention enables the generation of a real-time or near real-time offer based on the user's declaration of intent.

The invention enables a user to transmit the user's purchase intent to a system associated with a financial institution (e.g., via the user's financial institution account). Therefore, the financial institution becomes a market maker in a local market. For example, the user may transmit to the financial institution the user's intent to eat Italian food along with a group of ten of the user's friends (e.g., a collective intended purchase). The user may input the user's intent onto a user interface associated with the user's financial institution account. Each of the users in the group of users may or may not have accounts associated with the financial institution.

Additionally, the user may specify the approximate geographic location associated with the user's intent. For example, the user may specify that the user intends to eat Italian food in the Charlotte Uptown area (or the user may specify a street address, a zip code, or the like). When the user does not specify a location, the user interface may prompt the user to input a location. If the user does not specify a location, the system may determine the user's location as the location of the computing device (e.g., portable mobile communication device) used by the user (e.g., using GPS data, network address data, or the like, associated with the computing device) to transmit the user's intent. Alternatively, if the user does not specify a location, the system may determine a default location based on pre-established user information (e.g., the user's residence address, the user's workplace address, or the like).

In some embodiments, the declaration of intent is associated with a type of purchase (e.g., the user intends to eat Italian food for dinner tonight) or a type of merchant (e.g., the user intends to eat dinner at an Italian restaurant tonight). As an example, when the user transmits an intent to eat Italian food for dinner tonight, the system may transmit the user's intent to both Italian restaurants and non-Italian restaurants that serve Italian food.

In some embodiments, each merchant may be categorized on the type of product or service that the merchant offers. Additionally, in some embodiments, each merchant may be categorized based on the merchant's location (e.g., street address, zip code, or the like). In some embodiments, each merchant may be associated with a banking center (e.g., office) location associated with the financial institution or associated with an ATM (Automated Teller Machine) location associated with the financial institution. Additionally, in some embodiments, each merchant may be categorized based on purchase amounts or budgets associated with typical purchase transactions. For example, the merchant may classified on a budget scale as a high-end merchant (higher budget required for typical purchase transactions), an intermediate merchant (intermediate budget required for typical purchase transactions), or a low-end merchant (lower budget required for typical purchase transactions). In some embodiments, the system may access a database of categorized merchants that has been either created by the financial institution or has been created by an entity other than the financial institution. The system may query the database to determine merchants associated with the user's declaration of intent.

In some embodiments, the declaration of intent is associated with a user-defined budget. For example, the user inputs a budget associated with the user's intended purchase. When the user does not input a budget, the user interface may prompt the user to input a budget. If the user does not specify a budget, the system may automatically determine a budget based on at least one of account information or user information associated with the user. For example, the system may determine a budget based on previously executed transactions related to the type of intended purchase and based on the number of other users in the group of users intending to execute a purchase transaction.

In some embodiments, the declaration of intent is associated with a user-selected time period. For example, the user inputs a time frame (e.g., around 8 PM tonight) associated with the user's intended purchase. When the user does not specify a time period, the user interface may prompt the user to input a time period. If the user does not specify a time period, the system may determine that the user would like to view real-time or near real-time offers associated with the user's intended purchase, which purchase the user would like to make as soon as possible.

The system described herein receives the declaration of intent from the user's computing device. As indicated previously, in some embodiments, the declaration of intent is received via a financial institution account. In other embodiments, the declaration of intent may be received via other modes of communication (e.g., email, text message, phone call, voice mail, or the like). In still other embodiments, the declaration of intent may be received via the user's social networking account.

The user's declaration of intent is processed by the system described herein and transmitted to merchants associated with the particular type of intent (e.g., Italian food), associated with a particular geographical location (e.g., Charlotte Uptown), and associated with the user's budget (e.g., $10 per user). The transmission (e.g., a message) from the system to the merchants may or may not identify the user associated with the declaration of intent. In embodiments where the transmission identifies the user, the transmission may also include at least one of account information or user information associated with the user. For example, the transmission may include the user's transaction history associated with the merchant that receives the transmission. Therefore, each merchant that receives the transmission from the system may receive the user's transaction history associated with that particular merchant.

As indicated previously, in some embodiments, the declaration of intent may be associated with a plurality of users. Therefore, the user submits the user's intent on behalf of a group of users. The user (i.e., the primary user) may specify the number of users (i.e., the secondary users) and other details about the secondary users (e.g., age group, gender, or the like). In some embodiments, the user may specify the names (or other identification information or contact information) associated with each user in the group of users. In some embodiments, the system may identify a secondary user and pull account information and/or user information associated with the secondary user based on information provided by the primary user. In some embodiments, each user in the group of users may need to submit a declaration of intent to the system.

In some embodiments, the at least one merchant is given a predetermined period to transmit to the system the offer associated with the declaration of intent. For example, if the user's intent indicates that the user intends to make a purchase at 8 PM tonight, the system described herein may indicate to the merchant that the merchant needs to transmit the merchant's offer by 6 PM tonight. As a further example, if the user indicates that the user intends to make a purchase now, the system may indicate to the merchant that the merchant needs to transmit the merchant's offer substantially instantaneously (e.g., in real-time or near real-time).

The system described herein receives offers from merchants that choose to provide offers. In some embodiments, the system receives offers from various merchants, amalgamates the offers into a single message, and transmits the message to the user. In other embodiments, as the system receives offers from various merchants, the system forwards the offers to the user (therefore, there may be a gap of time between the user's receipt of a first offer and receipt of a second offer). In still other embodiments, the merchants may directly transmit their offers to the user based on contact information provided by the system to the merchants. The offers provided by the merchants may be valid for a specified time period (e.g., a time period corresponding to a time period specified in the user's declaration of intent), a specified number of users (e.g., ten users), a specified purchase amount (e.g., at least $10 per user), a specified payment method (e.g., payment card associated with the financial institution), or the like. As used herein, payment via a payment card may also refer to payment via a mobile wallet associated with a mobile device.

The offers may be transmitted to the user from the system, and the user may forward the offers to the other users in the group of users. Additionally or alternatively, the offers may be transmitted from the system (or the merchant) to each identifiable user in the group of users. Therefore, the user (and/or the group of users) may browse the received offers on their mobile devices. The offer selected by the user (and/or the group of users) may be activated by the user or any other user in the group of users. As an example, the selected offer may be associated with a bigger discount or rebate compared to the other offers. Once the offer is activated, the user (and/or the group of users) may visit the merchant's establishment and make a purchase transaction that qualifies for the offer.

As explained previously, the purchase transaction may be associated with a group of users. If the user that activated the offer pays the amount of the purchase transaction using a payment method that qualifies for the activated offer, the discount or rebate associated with the offer is applied to the user's financial institution account upon settlement of the purchase transaction and/or the activated offer. If the user that activated the offer is different from the user that pays the amount of the purchase transaction using a payment method that qualifies for the activated offer, the discount or rebate associated with the offer may be applied to the financial institution account of the user that pays for the purchase (and not the user that activated the offer) upon settlement of the purchase transaction and/or the activated offer. In some embodiments, the merchant and/or the financial institution may identify the purchase transaction based on information associated with the declaration of intent (e.g., size of group, time period associated with purchase transaction, or the like). In embodiments where the system cannot apply the discount or rebate to the financial institution account of the user that paid the amount of the purchase transaction, the system applies the discount or rebate to the financial institution account of the user that activated the offer.

In some embodiments, the discount or rebate is applied to a transaction associated with each of the plurality of users. For example, the offer may have been activated by at least one user in the group of users, and each user in the group of users may pay for his or her individual portion of the payment amount. In such embodiments, the discount or rebate associated with the offer may be applied to each user's financial institution account upon settlement of the purchase transactions and/or the activated offer. Therefore, each user in the group of users may receive the 10% off discount or rebate associated with the offer. In some embodiments, the merchant and/or the financial institution may identify the purchase transaction based on information associated with the declaration of intent (e.g., size of group, time period associated with purchase transaction, or the like).

In some embodiments, the offer is transmitted to the user based on offer information associated with the offer substantially matching at least one of user information or account information associated with the user (and/or other users in the group of users associated with the intended purchase). As described herein, the account information comprises a transaction history associated with the user's financial institution account, and wherein the transaction history comprises at least one of a type of a transaction, a frequency associated with the transaction, an amount associated with the transaction, or a merchant associated with the transaction. As described herein, the user information comprises personal information associated with at least one of the user, a family member of the user, or a friend of the user, wherein the personal information comprises at least one of demographic information, salary information, contact information, residence address information, job profile information, education information, or social network information.

As described herein, the offer is transmitted to the user based on the user (and/or other users in the group of users associated with the intended purchase) not being excluded by at least one user exclusion rule and the merchant not being excluded by at least one merchant exclusion rule, wherein the at least one user exclusion rule comprises at least one of an affinity exclusion rule, a risk exclusion rule, or an account exclusion rule. Additionally, as described herein, the at least one merchant exclusion rule comprises a merchant category code exclusion rule. As described herein, the at least one merchant exclusion rule is based at least partially on a list of merchants associated with an excluded merchant category code that are not excluded.

As described herein, the offer is presented to the user on a portable mobile communication device. As described herein, a transaction associated with the intended purchase comprises: at least one purchase associated with a predetermined period, at least one purchase associated with a predetermined amount, an aggregate of a plurality of purchases, or a largest purchase.

As described herein, the offer is transmitted via at least one of a user interface associated with the user's financial institution account, a user interface associated with the user's social network account, email, or text message.

As described herein, the processing or settlement of a transaction associated with the intended purchase is executed as part of a batch processing operation, wherein the batch processing operation comprises processing a plurality of financial institution accounts, and wherein the discount or rebate associated with the offer is applied to a financial institution account either during or upon conclusion of the batch processing operation.

Any of the features described herein with respect to a particular process flow are also applicable to any other process flow. In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An apparatus for transmitting offers based on pre-purchase intent, the apparatus comprising:
a memory;
a processor; and
a module stored in the memory, executable by the processor, and configured to:
receive a declaration of intent from a user, the declaration of intent being associated with an intended purchase;
transmit the declaration of intent to at least one merchant;
receive an offer from the at least one merchant, the offer being based on the declaration of intent, and the offer enabling the user to receive a discount or rebate on the intended purchase; and
transmit the offer to the user.

2. The apparatus of claim 1, wherein the declaration of intent is associated with at least one of a type of purchase or a type of merchant.

3. The apparatus of claim 2, wherein the declaration of intent is associated with at least one of a user-selected time period or a user-defined budget.

4. The apparatus of claim 3, wherein the declaration of intent is associated with a geographical area.

5. The apparatus of claim 1, wherein the transmitting the declaration of intent to at least one merchant comprises transmitting the declaration of intent along with at least one of user information or account information associated with the user.

6. The apparatus of claim 1, wherein the declaration of intent is associated with a plurality of users.

7. The apparatus of claim 6, wherein the module is configured to identify each of the plurality of users.

8. The apparatus of claim 6, wherein the discount or rebate is applied to a transaction associated with each of the plurality of users.

9. The apparatus of claim 6, wherein a first user, among the plurality of users, activates the offer, and wherein a second user, among the plurality of users, executes a transaction associated with the intended purchase.

10. The apparatus of claim 1, wherein the declaration of intent is received via at least one of a financial institution account, a social networking account, email, voice mail, or text message.

11. The apparatus of claim 1, wherein the at least one merchant is given a predetermined period to transmit or provide the offer associated with the declaration of intent.

12. The apparatus of claim 1, wherein the offer is transmitted to the user in real-time or near real-time.

13. The apparatus of claim 1, wherein the offer is transmitted to the user based on offer information associated with the offer substantially matching at least one of user information or account information associated with the user, wherein the account information comprises a transaction history associated with the user's financial institution account, and wherein the transaction history comprises at least one of a type of a transaction, a frequency associated with the transaction, an amount associated with the transaction, or a merchant associated with the transaction, and wherein the user information comprises personal information associated with at least one of the user, a family member of the user, or a friend of the user, wherein the personal information comprises at least one of demographic information, salary information, contact information, residence address information, job profile information, education information, or social network information.

14. The apparatus of claim 1, wherein the offer is transmitted to the user based on the user not being excluded by at least one user exclusion rule and the merchant not being excluded by at least one merchant exclusion rule, wherein the at least one user exclusion rule comprises at least one of an affinity exclusion rule, a risk exclusion rule, or an account exclusion rule, and wherein the at least one merchant exclusion rule comprises a merchant category code exclusion rule, and wherein the at least one merchant exclusion rule is based at least partially on a list of merchants associated with an excluded merchant category code that are not excluded.

15. The apparatus of claim 1, wherein the offer is presented to the user on a portable mobile communication device.

16. The apparatus of claim 1, wherein a transaction associated with the intended purchase comprises: at least one purchase associated with a predetermined period, at least one purchase associated with a predetermined amount, an aggregate of a plurality of purchases, or a largest purchase.

17. The apparatus of claim 1, wherein the offer is transmitted via at least one of a user interface associated with the user's financial institution account, a user interface associated with the user's social network account, email, or text message.

18. The apparatus of claim 1, wherein the processing of a transaction associated with the intended purchase is executed as part of a batch processing operation, wherein the batch processing operation comprises processing a plurality of financial institution accounts.

19. A method for transmitting offers based on pre-purchase intent, the method comprising:
receiving a declaration of intent from a user, the declaration of intent being associated with an intended purchase;
transmitting the declaration of intent to at least one merchant;
receiving an offer from the at least one merchant, the offer being based on the declaration of intent, and the offer enabling the user to receive a discount or rebate on the intended purchase; and
transmitting the offer to the user.

20. A computer program product for transmitting offers based on pre-purchase intent, the computer program product comprising:
a non-transitory computer-readable medium comprising a set of codes for causing a computer to:
receive a declaration of intent from a user, the declaration of intent being associated with an intended purchase;
transmit the declaration of intent to at least one merchant;
receive an offer from the at least one merchant, the offer being based on the declaration of intent, and the offer enabling the user to receive a discount or rebate on the intended purchase; and
transmit the offer to the user.
